(19) United States
(12) Patent Application Publication
(10) Pub. No.: US 2024/0346064 A1
(43) Pub. Date: Oct. 17, 2024

(54) SYSTEM AND METHOD FOR IDENTIFYING AND DISPLAYING ASSOCIATIONS AND CONNECTIONS BETWEEN DIGITAL MEDIA OBJECTS

(71) Applicant: Helper Systems, LLC, Helper, UT (US)

(72) Inventors: Christopher Mullins Warnock, Helper, UT (US); Jean-Michel Pierre Decombe, Point Richmond, CA (US)

(21) Appl. No.: 18/429,375

(22) Filed: Jan. 31, 2024

Related U.S. Application Data
(60) Provisional application No. 63/482,585, filed on Jan. 31, 2023.
(60) Provisional application No. 63/482,737, filed on Feb. 1, 2023.

(51) Int. Cl. G06F 16/438; G06F 16/44; G06F 40/205

(52) U.S. Cl. CPC G06F 16/4393; G06F 16/44; G06F 40/205

(57) ABSTRACT

A system and method for data management providing a unique combination of tools that enable a user to bring digital media that include text, image, video, audio data, metadata, or a combination thereof and to place them within an application that automatically processes the digital media as they are input into user defined Spaces, wherein the user places digital media in specific Spaces in order to perform comparisons of all the digital media within a selected Space, wherein the application identifies associations between the digital media in the selected Space, may assign weights to those associations, may sort those associations by weight, and may then render in a visual display the identified associations using the criteria of boards, timelines, calendars, geography, selected categories, charts, virtual and augmented reality spaces and networks, and wherein the user may publish the associations in a visual manner and in a desired format.

### CROSS-REFERENCE TO RELATED APPLICATIONS

This application claims priority to U.S. Provisional Application Ser. No. 63/482,585 filed on Jan. 31, 2023, for SYSTEM AND METHOD FOR IDENTIFYING AND DISPLAYING ASSOCIATIONS AND CONNECTIONS BETWEEN DIGITAL MEDIA OBJECTS and U.S. Provisional Application Ser. No. 63/482,737 filed on Feb. 1, 2023, for SYSTEM AND METHOD FOR IDENTIFYING AND DISPLAYING ASSOCIATIONS AND CONNECTIONS BETWEEN DIGITAL MEDIA OBJECTS filed on Feb. 1, 2023, the entirety of each of which is incorporated herein by this reference.

### FIELD OF THE INVENTION

This invention relates generally to a suite of services that in combination are able to provide an unprecedented level of organization, rendering, visualization, and analysis of digital files. More specifically, the invention is related to facilitating management of digital media objects, which may include text-based documents, images, videos, audio files, as well as compound documents (e.g., PDF, HTML, ePub, etc.) or files containing multiple types of media, enabling users to identify associations and connections between digital media objects by inputting, indexing, rendering and analyzing by visually and/or contextually identifying associations and connections between the digital media objects, which may include spatial (e.g., map, board, augmented reality, virtual reality, etc.), temporal (e.g., calendar, timeline, etc.), and/or logical (e.g., gallery, table, 3D, etc.) associations and/or connections between the digital media objects, weighting these associations and/or connections, and comparing, collaborating on, sorting, rendering, publishing, and storing the indexed and analyzed information from the digital media objects.

### DESCRIPTION OF RELATED ART

The ability to meaningfully manage large quantities of data has rapidly declined as the volume of data has exponentially increased. The increase in data volume may be attributed to several different factors. For example, more and more information is being added to the global library that is found on the Internet. Several years ago, it was acknowledged that there were some 2.5 quintillion bytes of data created each day at the current pace. Furthermore, that pace is only accelerating with the growth of the Internet of Things. It was estimated that over the last two years alone, 90 percent of the data that can be found on the Internet was generated within that time frame. In other words, new data creation is increasing at an ever-quickening exponential pace. It is obvious that the colossal amounts of data created every day is simply too vast to comprehend. While Adobe portable document format (“PDF”) documents represent just one type of digital media object file, according to statistics gathered by Adobe and presented by the PDF Association, in 2016, 243,688,400 users opened 12.3 billion PDF documents alone. By 2018, those numbers grew to 338,801,280 users opening 19.5 billion PDF documents, an increase of 59%. A tool that could only organize, manage, and analyze PDF documents according to their content would still be a major advancement in the art.

Unfortunately, however, our ability to generate and create this vast amount of data has outpaced our ability to organize, manage, and utilize such information in an efficient and useful manner that would allow us to truly benefit from these vast quantities of data. For example, we typically rely on the indexes of search engines to comb through text data to provide us with search results that are ranked from most to least relevant. For Internet searches, for example, most search engines utilize a set of search criteria in an attempt to provide the user with a set of search results that are most relevant for that user. For example, the search criteria may include the user's geographic location to provide search results that contain information that is geographically closer to the geographic location of the user. In any case, the user is typically not able to control how the search engine ranks or organizes the search results with the search results simply being ranked from most to least relevant according to the predetermined search criteria of the search engine being utilized. Moreover, the interrelatedness or commonality of the search results or any two or more of the search results is not provided. That is, once the search results are displayed, it I up to the user to review each of the search results to determine the actual relevance of each search result and whether or not any one search result has information that might be related or connected to another one or more of the other search results.

In addition to public data that may be searched and found on the Internet, for example, there can also be a significant amount of data that is personal or private data generated or collected by a single user or a group of users that may not be provided to the public or otherwise become part of the vast amounts of public data. That is, the personal or private data may not be part of any public database such as a public website, public depository of digital information or other Internet database. This data may thus be strictly personal or private data (hereinafter “private data”) that may belong to an individual, a group of individuals, a business or organization, or a group of businesses or organizations, and may be stored on one or more personal computers, servers, mobile devices or other data storage systems or devices. For example, a user may be an individual that takes photos, records videos, records audio, creates documents and also downloads and stores other digital media objects. While not publicly shared, such a may be performing these activities for personal use, for business purposes, or for both.

Similarly, there may be a group of users that are collaborating on a project that generate digital content that is stored and becomes part of the private data. This group may be an association with a common interest, or they may be a group of employees within a company working on a specific project. This private data may be created solely by the user(s), may be a collection of data from public sources, or it may be a combination of both private and downloaded public data. Thus far, the tools available for data management, organization and retrieval to single users or groups of users have been extremely limited in scope and versatility.

Whether the data is private, public or a combination of these, a byproduct of our information age is that we have a vast amount of data that we create and/or accumulate, and we have no practical and efficient way to organize it, analyze it, extracting useful information from it, compare it, share it, or collaborate on it in a meaningful and efficient manner in order to determine the true value of such information. Indeed, some of the information contained in such vast amounts of data can become lost due simply to the sheer quantity of data involved. As such, much of this data may remain stored on hard drives, on USB drives, and in storage sites in the Cloud, without ever knowing its true worth waiting for a meaningful, useful, and highly efficient data management system to unlock its true potential.

As used herein, the terms “media object” and “media object file” refer to the set of digital data that may be stored in text documents, images, videos, audio files, and in metadata associated with these files, as well as compound documents here again-PDF, HTML, ePub, etc. Thus, a media object file may be any type of digital data from any form of media including, but not limited to, textual, visual, and auditory forms.

Accordingly, it would be an advantage over the prior art to provide a system and method for data management that enables a user or group of users to organize, analyze extract, compare, share, and collaborate on a set of digital media objects files, whether such set of digital media objects files be from private and/or public media objects file sources, and whether that data comprises textual, visual, audio, metadata and/or combinations of these different media types. This is accomplished by a system and method that enables a user or group of users to visually and contextually discover, explore, sort, select, render, visualize, tag, annotate, publish, and selectively store digital media objects files and select information associated therewith in an efficient, useful and advantageous way.

### BRIEF SUMMARY OF THE INVENTION

Accordingly, the present invention provides a system and method for data management that comprises a unique combination of tools to enable a user to bring digital media objects that may include one or more of, or a combination of, text, image, video, audio data, metadata or any other form of digital media into an application that processes the media objects loaded into the system according to user selectable and/or system defined parameters. Each of the digital media objects may be placed by the user in one or more user defined “Spaces,” wherein the user places media objects in specific Spaces in order to perform comparisons of all the media objects within a specific Space, wherein the application may identify associations between the media objects in a specific Space, may assign weights to those associations, may sort those associations by weight, and may then render in a visual display the identified associations using the criteria of boards, timelines, calendars, geography, and by selected categories, and wherein the user may publish the associations in a visual manner and in a desired format.

Additionally, the system and method of the invention allows the user to create or modify digital media objects, Spaces, entities, etc., is configured to generate or modify digital media objects, Spaces, entities, etc., while giving the user the ability to validate what the system generates or modifies (e.g., approve, reject, auto-approve for optional deletion later (such as for entities)). Thus, the system and method of the invention is configured to provide the user with certain elaboration functionality as well as the engine of the system with certain automation capabilities.

In one aspect of the invention, as the digital media objects are uploaded or imported into the system, the information they contain is indexed. In order to be able to index such files, however, each file must contain recognizable/readable information, whether that be in the form of readable text, transcribed audio/video, rendered images/video, etc. For example, in the case where the digital media object file comprises an Adobe PDF image file containing text, if not already in readable text format, the file can be subject to the Adobe PDF optical character recognition (OCR) tool to transform the image text file into searchable text. The system itself may include various OCR and/or transcription tools to convert non-readable image, audio or video files into files containing readable and searchable textual or other indexable information.

In another aspect of the invention, when uploaded or imported into the system, each file is placed into a directory structure with a Home Space as a root directory and one or more Sub-Spaces as subfolders within the Home Space or Sub-Spaces. The Home Pace and Sub-Spaces, however, are not necessarily strictly hierarchical in nature as they are in Finder (MacOS) or Explorer (MS Windows). Rather, each Space or Sub-Space can be dynamically changed by the user or the system with a depth selector between deep and flat representations so as to bring all of the Spaces to the same level, if desired, certain Spaces to the same level with others at a lower level, etc. Similarly, the system may be configured with table view with the hierarchical structure capable of being changed dynamically in a similar manner. This allows information contained in certain Spaces or Sub-Spaces to be compared with other Spaces or Sub-Spaces in any order regardless of the initial hierarchical structure. Alternatively, or in addition to, the Spaces and Sub-Spaces may be arranged in a mind-map arrangement with the Home Space containing media objects relating to a main topic, for example, and each Sub-Space branching out from the Home Space. Again, the depth of each of the Space or Sub-Space may be dynamically changed by the user or the system as previously mentioned media objects In yet another aspect of the invention, one or more Cards may be created for each media object file. The Cards contain the indexed and other information generated from or associated with the media objects and are linked to those specific media object file(s).

In another aspect of the invention, a word cloud operation is performed on at least one Card, but may include two or more Cards, to thereby identify associations, similarities, commonalities, connections, relationships and/or parallels between words, phrases, and/or entities between the selected Cards. This may include all of the Cards contained in the Home Space or, for example, selected set of Cards associated with a user selected set of media objects.

In still another aspect of the invention, two or more Cards may be visually rendered in a manner in which identified associations between selected Cards in terms of words, phrases, entities or other commonalities that are common to both of the Cards are displayed. This provides a Venn Cloud feature and intersection functionality. Other aspects of the invention include the capability to the ability to extract tables of contents, page thumbnails, and other navigational features from media objects of any type.

Yet other aspects of the invention include the capability to generate annotations, tags or other user created or engine automated references, citations or the like to be associated with a particular media object or set of media objects.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 shows a Home Space with Cards and Sub Spaces arranged in a gallery view.

FIG. 2 is another illustration of a Home Space showing different groupings of Cards.

FIG. 3 is another illustration of a Home Space that demonstrates the versatility of how Cards may be displayed.

FIG. 4 is a flowchart that describes the framework of the kOS application.

FIG. 5 is a table showing metadata that may be stored by each Space.

FIG. 6 is an illustration of a Gallery view of a plurality of different Cards that are stored in a Space.

FIG. 7 is an illustration of how content may be selected from a URL and dragged into a Space to create a new Card that includes image data and text data.

FIG. 8 is a block diagram of the overall framework of the kOS application of the first embodiment.

FIG. 9 is a block diagram of the step of indexing.

FIG. 10 is an illustration in a Space of how associations between Cards may be visually displayed using arrows to show a selected document near the center of the display.

FIG. 11 is an illustration of a Space that shows user interface “visual clues” to show the Cards that meet the search results.

FIG. 12 is an illustration of a Space that shows the Cards may be placed on a gallery style Calendar to show chronological organization of the Cards.

FIG. 13 is an illustration of a Space that shows a single day calendar view.

FIG. 14 is an illustration of a Space that shows a timeline view of the Cards.

FIG. 15 is an illustration of a map showing a geographical view of the Cards.

FIG. 16 is another illustration of a map showing a geographical view of the Cards.

FIG. 17 is an illustration of a categorical view of Cards in which Cards may be placed in a list with columns that correspond to metadata and user created tags.

FIG. 18 is an illustration of a categorical view of Cards in which Cards may be placed in groups that correspond to metadata and user created tags.

FIG. 19 is an illustration of an example of a plurality of Card types in a Space, with a single Card selected, and then a word cloud associated with the selected Card.

FIG. 20 is an illustration of an example of a plurality of Cards in a Space, but with several Cards selected based on a word cloud.

FIG. 21 is an illustration of an example of a quick tour.

FIG. 22 is an illustration of a kBase window with toolbar, gallery context, table of context tab, and word cloud tab.

FIG. 23 is an illustration of an example of page thumbnails and phrase builder tabs.

FIG. 24 is an illustration of an example of a favorites tab.

FIG. 25 is an illustration of an example of a table of context, table of contents editor, and word cloud with filter bubble.

FIG. 26 is an illustration of an example of a properties tab with summaries.

FIG. 27 is an illustration of an example of floating palettes.

FIG. 28 is an illustration of an example of content with highlights, content selection bubble, and notes tab.

FIG. 29 is an illustration of an example of an artificial intelligence tab.

FIG. 30 is an illustration of an example of a presentation mode with playback toolbar.

FIG. 31 is an illustration of an example of a presentation slide.

FIG. 32 is an illustration of an example of a kBase information bubble.

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

As used herein the following definitions are provided.

Card means a digital media object that has been added to the kOS application, and to a graphical representation of the digital media object, to which a set of operations have been applied (including but not limited to certain indexing operations) regardless of media type, including textual (documents, structures, table of contents, spreadsheets), HTML, annotations, audio, video, photography, graphical, annotation, etc., and in which such digital media object remains viewable within the kOS application as if such digital media object remains in its native file format.

Digital media object is a file, set of files, or bitstream that can be rendered into tangible media. A digital media object is not necessarily a single file. Sometimes multiple files are needed to render the finished media. This could include an audio file and a video file. Or it could be a package of files. (E.g., an Apple Keynote document is a package of individual media files and a controller file.) The digital source could also be a bitstream, like a streaming video playing as an embedded object in a web page. The essential quality of a digital media object is that it can be turned into actual media. This could be a document, photo, video, audio presentation or other thing you can see, hear or experience in a tangible way. This provides a useful separation from the more generalized concept of a digital object, which could be a chunk of software code, a password, or some other thing that does not ever need to be rendered to be useful. A digital object could have a very complex internal structure (e.g., a DVD is a digital object that may be made up of hundreds of component files). Or it could be very simple, like a PNG image. It could be something that should be rendered in only one way, like a profile-tagged JPEG, or something that could be rendered in all kinds of ways, like a camera raw file. Reference herein to digital media objects includes any and all accompanying media entities.

Entity is defined as information representing a thing capable of an independent existence that can be uniquely identified, i.e., an aspect of the real world that can be distinguished from other aspects of the real world that exists either physically or logically. For example, an entity may be a physical object such as a house or a car (both exist physically) or a place (such as a city, state or country), or an event (such as a house sale or a date of birth) or a customer transaction or order (both exist logically).

kOS application means the system software of the present invention, which may comprise a stand-alone application to be loaded onto a personal computer or mobile device having its own operating system (e.g., Microsoft Windows, Apple MacOS, Apple IOS, Android OS, etc.) or may be the basis for an operating system itself.

Media entity is an item of content data, such as metadata, which may consist of text, HTML markup, images, or any other data. Such media entities when applied to digital media objects refer to data that represents media resources. Examples include images, documents, audio files, remote videos, and even things like an Instagram or Twitter URL that do not necessarily fit into the traditional definition of digital media. For example, the entity for an image file (a resource) may include some associated tags for organizing purposes, a photo credit naming the photographer, geographic location information of the photo and date the photo was taken. Likewise, the media entity for an image from an Instagram URL (a resource) may include comments, likes, and metadata, as well as resource-specific logic for creating an HTML representation of the thing to display. Every individual digital media object, whether an image, a remote video on YouTube, or a PDF file, most often includes a media entity.

Metadata is the data accompanying a digital media object that provides information about one or more aspects of the digital media object or parts thereof and is used to summarize basic information about the digital media object. Some examples include the purpose of the digital media object or parts thereof, time and date of creation, creator or author, location where created, standards used, file size, data/image quality, source of the data and process or system used to create the digital media object or parts thereof. The metadata of the present invention as it applies to digital media objects analyzed by the kOS system may include both user and system created or generated content and/or information.

As used herein below:

Space means a system defined location for storing or indexing digital media objects imported into the system.

Compounds are the ability to represent any space, subspace, or subset of cards within in the table of contents, page thumbnails, word cloud, phrase builder, and other navigation and information visualizations. For example, the compound table of contents of an entire set of documents (i.e. a space of cards) can be explored easily, which is not possible in any existing application. The same applies to the compound grid of page thumbnails, the compound word cloud of all concepts in all or only selected documents in a space or subspace, etc.

Extracts provide the ability to extract any kOS object into a card at any level of granularity. Since the card resulting from the extraction belongs to a space or a subspace, it can be used like any other document, except that it is just a subset of a document, such as a chapter or page from a text, a detail from an image, a scene from a video, etc.

As a result, a space or subspace can contain a mix of documents, chapters, pages, excerpts, etc. Since the selection of cards made in the current context, e.g. the gallery, controls the scope of what is displayed in the table of contents, page thumbnails, word cloud, phrase builder, and other navigation and information visualizations, it is possible to see the word cloud of a single page, the page thumbnails of a single chapter, etc. Since a presentation is based on a playlist of cards in a space or subspace, it can now include slides based on a text excerpt, an image detail, a video scene, etc.

Scopes provide the ability to adjust the scope of what is displayed in any information visualization based on the navigation object being currently viewed. For example, the word cloud and phrase builder are dynamically updated as the user navigates to a specific chapter or page of a document using the table of contents or page thumbnails.

This is equivalent to what can be achieved with extracts, albeit with some limitations. The method is more immediate, e.g. with the scope set to chapter, the word cloud is updated dynamically as the user scrolls through a document, going from chapter to chapter, giving that user a visual overview of each chapter. However, the method is less flexible, e.g. it is not possible to combine multiple pages and chapters from various documents to see their combined word cloud, and it is not possible to see the word cloud of a note or a chat interaction.

The scope even applies to any interaction with artificial intelligence. For example, it is possible\ to generate a summary, an illustration, a video, a soundtrack, and more for the current kBase, set, document, chapter, page, excerpt, etc. It is also possible to ask questions (prompts) in the scope and receive responses, or to request bibliographic information for the scope.

Favorites provide the ability to favorite objects at any level of granularity, including a kBase, a set, a subset, a document, a chapter, a page, an excerpt, a concept, etc. All these favorited objects can be collected and accessed in just one place for easy recall, which is not typically possible in existing applications.

The present invention provides a method and system for indexing, organizing, analyzing, rendering and visually displaying information contained within digital media objects in a variety of ways that assists the user in identifying, analyzing and utilizing associations, similarities, commonalities, connections, relationships and/or parallels between select digital media objects. While the method and system could be useful on any type of digital file, the invention has particular applicability for digital media objects containing text, graphic, video, audio, HTML, and/or metadata and entities associated therewith. In the digital world, people create and collect a vast array of information including documents, photographs, graphics, images, videos, audio files and other digital media. This disjointed set of information or media objects, because they can be any type of media format, create chaos for all users that try to manage the information.

The embodiments of the present invention are directed to enabling individuals and groups to not only solve basic problems associated with organizing, collaborating on, and sharing media objects, but to augment the media objects within the system through the creation of both automatically generated (i.e., engine or system implemented protocols or tools) or user created or added associated content for providing such additional or supplemental information to the user from these associations, links and/or connections of both inter-media and intra-media content such as entity extraction, summarization, topic clustering, feature detection, etc., and to display such supplemental information to the user through various forms of two dimensional and/or simulated three-dimensional visualizations.

The first embodiment of the invention is an application referred to as the kOS application. The kOS application is a suite of services that allows a user to selectively upload or imports digital media objects, index the digital media objects, organize the digital media objects, and find associations, similarities, commonalities, connections, relationships and/or parallels between the information contained in the files and their associated metadata. This information may then be visually presented to the user in a number of ways so that the similarities, commonalities, connections, relationships and/or parallels can be made more readily apparent to the user by how the media objects are displayed.

In summary, each individual media object file may be presented to the kOS application, by for example selecting the media object file from a file directory (e.g., Finder window for MacOS or Explorer window for Microsoft Windows) or dragging and dropping the media object files onto the Home Space of the kOS application. The kOS application then automatically indexes each digital media object file, to allow the kOS application to find associations, similarities, commonalities, connections, relationships and/or parallels according to user selected and/or system provided protocols. The system then sorts, organizes, renders, publishes and stores the indexed digital media objects. The kOS application automatically generates a visual representation of the associations, similarities, commonalities, connections, relationships and/or parallels according to the user selected and/or system provided protocols. The kOS application further provides a collaboration and/or annotation tool, that allows users to add annotations, comments, mark-ups, citations and/or other tags or notations to the digital media objects that are stored therewith as metadata to the digital media object file or as a separate Card but linked to the Card of the digital media object to which the annotations, comments, mark-ups, citations and/or other tags or notations apply.

Before explaining how the present invention functions, in a first embodiment of the invention, the kOS application requires a structure or framework for a hybrid file management system in order to function. In this embodiment, the basic framework of the system begins with identification of a user-defined Space that allows a user to upload or imports digital media objects (herein referred to as “Cards”) to the Space and to visually organize the digital media objects within the Space. A Space is basically a container (Space, Directory Location, Folder, etc.) that holds the Cards and any user-created Sub-Spaces (e.g., subfolders) within the Space, and that defines the group of Cards that belong to the particular Space and are to be analyzed for associations, similarities, commonalities, connections, relationships and/or parallels between the Cards contained within the Space. The Home Space may be the primary unit of work that organizes all digital media objects loaded into the Space and associated information within the system, with other Spaces and Sub-Spaces of the System containing subsets of all information contained within the Home Space. The Cards and associated system or user created metadata or user created Cards are sharable with collaborators through the system. It may be useful to think of the Space as a virtual area in which all Cards in the unit are indexed, analyzed for associations, similarities, commonalities, connections, relationships and/or parallels, and visually represented on the display in various ways that allows the user to visualize various the associations, similarities, commonalities, connections, relationships and/or parallels between Cards.

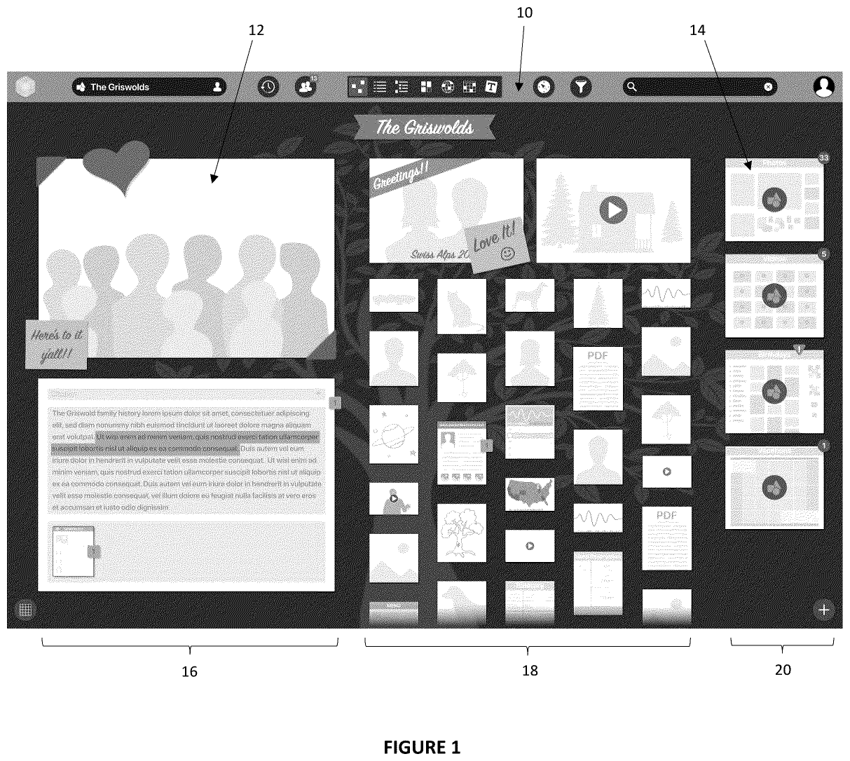

As shown in FIG. 1, a first virtual container or Space, generally indicated at 10, of the work area is akin to a computer desktop window or root directory. It may be a virtual starting location that contains both Cards (i.e., digital media objects) and other Spaces or Sub-Spaces and is customizable by the user. This embodiment features a toolbar at the top and a main view below. The toolbar features a context selector in the center to switch between gallery, table, timeline, calendar, map, board, and other contexts. The main view features three columns: a list of spaces on the right, each possibly in a different context; a list of all cards in the center, as a gallery; and a list of key cards on the left, which are viewed and can be edited, including an image at the top, decorated with a frame, a note, and a heart, as well as a document below that is being edited.

The Space 10 includes a plurality of Cards 12 and a plurality of Sub-Spaces 14 arranged in a gallery view. In this embodiment, the Space has been divided into three section or columns. The left column 16 contains two Cards 12. The center column 18 contains a plurality of thumbnails of Cards 12 and the right column 10 contains a plurality of Sub-Spaces 14. It should be understood that the arrangement of the Cards 12 and Sub-Spaces 14 shown in FIG. 1 is provided by way of example and not by limitation, and the exact layout may vary without departing from the spirit and scope of the invention. Each of the Cards 12, which includes representative thumbnail images and subspaces 14 may represent various types of digital media objects. For example, some Cards 12 may comprise documents containing text, images, audio clips or a video. Other Cards 12 may include mixed digital media in which one or more of text, images, audio and/or video are included in a single Card. In its most basic form, the Space provides an area on the display where a user can visually lay out Cards that represent different digital media objects and then select certain Cards or all Cards within the Space to enable the user to find associations, similarities, commonalities, connections, relationships and/or parallels between any number of sets of the Cards in the Space 10. The Space 10 could illustrate a Home Space where the Cards 12 and Sub-Spaces 14 displayed reside in the Home Space 10 and the Home Space 10 is essentially the root directory or highest level Space, from a hierarchical perspective. The Space 10 could also illustrate a Sub-Space where the Cards 12 and Sub-Spaces 14 displayed reside in the Sub-Space 10 and the Sub-Space 10 is a Sub-Space of another Sub-Space or a Home Space.

As illustrated, the Space 10 shown in FIG. 1 has a theme of “The Griswolds.” In such a case, for example, the user might include all known Cards 12 that deal with the subject of “The Griswolds” in the Space 10. The user can then use the kOS application to analyze those Cards 12 to determine any and all associations, similarities, commonalities, connections, relationships and/or parallels between all of the Cards 12 or between certain user selected Cards 12. In the case where the user desires to find associations, similarities, commonalities, connections, relationships and/or parallels between certain user selected Cards 12, the user can select by clicking and highlighting those Cards that are to be part of the comparison. When certain Cards 12 are selected by the user, the system will then only include the user selected Cards as part of the comparison analysis.

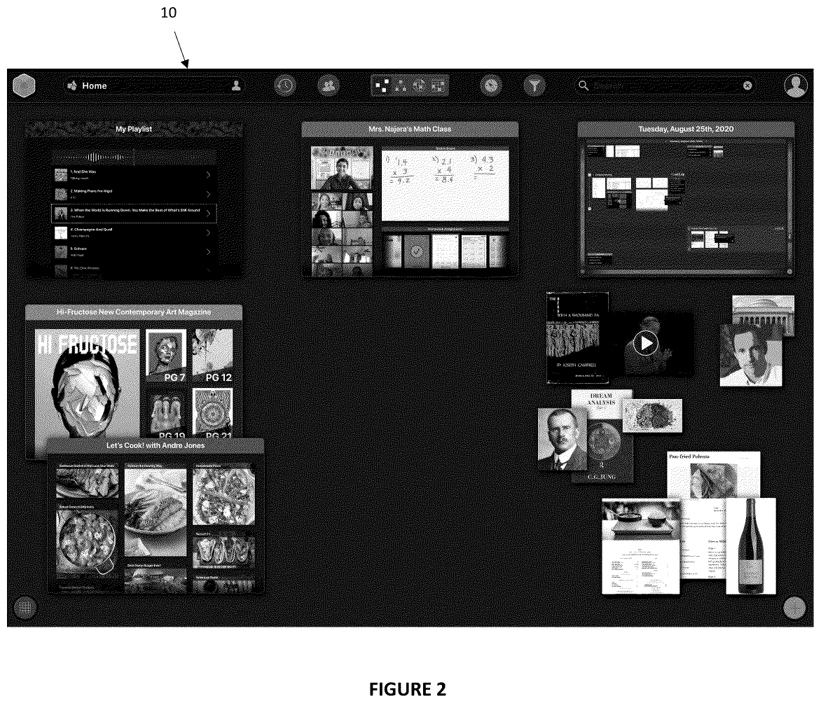

FIG. 2 illustrates another example of an arrangement of digital media objects on a Space, in this case a Home Space 10. This embodiment is similar to the one in FIG. 1, except that it is a board context where cards and spaces are organized in a free-form manner. Some of the spaces contain images, videos, etc. There is a space in the calendar context, in the upper right corner, that could even contain subspaces in other contexts. In this embodiment, the Home Space 10 is displaying several other Spaces, which may include various levels of Sub-Spaces, positioned along the left side and top of the Home Space 10 as well as a grouping of Cards in the lower right hand corner of the Home Space 10. The Sub-Spaces include a My Playlist Sub-Space containing several Audio Cards. Another Sub-Space contains several pages form the Hi-Fructose New Contemporary Art Magazine. Yet another Sub-Space includes a number of articles from Let's Cook with Andre Jones. Another Sub-Space includes Notes, photographs, and videos from Mrs. Najera's Math Class and yet another Sub-Space include different Cards from Tuesday Aug. 25, 2020. In this example, the user has arbitrarily determined the arrangement of Cards and Sub-Spaces and can select from each which elements to compare, whether of the same or different media types. Thus, the system is configured to allow for free and dynamic arrangement of digital media objects and Sub-Spaces by the user or may provide grid-like, cascading or other view arrangements selected by the user.

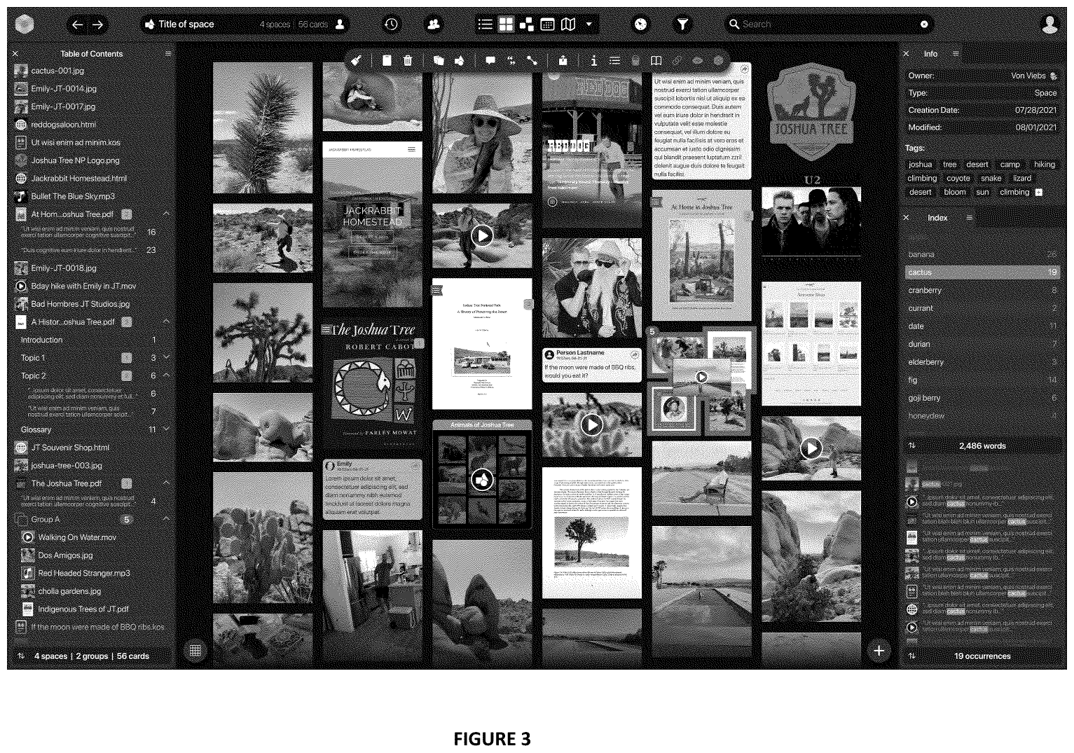

Referring now to FIG. 3, the Home Space 10 defines a visible page or window that is divided into three sections. The toolbar is at the top of the window, with the gallery below, as well as left and right sidebars that can be configured to stack sidebar tabs vertically within. The window can be sized by the user to fit all or a portion of the display screen, set to full screen or minimized as desired. The Cards to be analyzed are displayed in the middle window or column. A Table of Contents in a list view is provided in the left window or column. At the bottom of the Table of Contents is displayed the number of Spaces (4), the number of Groups in the current space (2), and the number of Cards in the current Group (56).

The Right hand window or column of the Home Space 10 provides information regarding the selected Cards (or all cards if none have been selected) in the center Space (i.e., the center window or column), including the Owner, a creation date, a modified date, and all of the tags that have been created or are being used in the Space.

The Cards that have been linked to this Space (which may be stored with the Space) are shown in the middle or center column of the display and include image, video, text and other digital media objects that include a mix of media types Cards with. All of the Cards within the Space have been indexed. The indexing of text may include a process to OCR the text in a document if not already containing machine readable text, to translate and transcribe audio files in order to convert audio voice recordings to machine readable text, to transcribe audio tracks in video files to machine readable text, to convert images and video clips to text describing the content of the images and video clips. For example, there are 2,486 words used to describe each image, and a list showing how many times each particular word is found in the index.

In order to analyze common word, phrase, or entity associations between various Cards within the system, the user can select on or more words, phrases or entities from a list of those found by the system from the indexed digital media files. For example, when the word “cactus” is selected from the Index, the system shows that the word “cactus” appears 19 times in the Cards that have been selected. Below that, the system displays an excerpt from each Card that shows where the word “cactus,” is used and the surrounding portion of the text (when provided in a text document). The user may then select a particular except form those listed in order to see the entire text associated with the Card that is selected. As will be described in more detail, when the user finds a reference of particular note or interest, the user can annotate, tag, comment on or otherwise mark the reference within the Card so that the reference can be easily located again later without having to search the Card again.

Most importantly, these Spaces and Sub-Spaces of the present invention have attributes and functions that are different from the metaphorical folders and sub-folders of typical prior art file systems, such as those found on MacOS or Microsoft Windows, to which they may initially appear on the surface to be related. That is, while the kOS application may appear to organize information in a similar fashion to a file/folder structure that is well known to computer and tablet users, the present invention adds new attributes and functions not found in the hierarchical file structure of the prior art.

This document begins with a description of Spaces. First, each user of the kOS application has a private Home Space that is inaccessible to other users. Thus, the kOS application on a local computer (hereinafter just a “computer”) may contain the data of more than one user.

The kOS application includes a hybrid directory structure capable of creating Sub Spaces to form a hierarchy of Spaces in a manner that in some aspects may be similar to folders and subfolders of typical prior art folder/file structures, where the topmost folder or root directory is like the Home Space and the subfolders or subdirectories are like the Sub-Spaces. In the present invention, however, the Sub-Spaces and their contents may be visible to the user even though the user is not displaying the Space or Sub-Space from which the Sub-Space or Card depends. The kOS hybrid file structure allows users to visually arrange Spaces, Sub-Spaces and Cards within a selected Space in any arrangement regardless of actual level of the Sub-Space or Card so that any information contained within the system can be retrieved and compared to any other Sub-Space or Card within the system.

Thus, the kOS system of the invention is comprised of an application that grants access to a workspace that is separate from and not necessarily constrained by the user's file and folder structure of the computer on which the kOS application is running. When the kOS application is started, it may require a user to enter a username and a password. In this way, the user's kOS Home Space workspace is protected from unauthorized access. In addition, the kOS system may be configured to be accessible on any computer that provides Internet access. In that case, it may only be necessary that the kOS application be installed on a computer that also has on-line access in order to retrieve the user's workspace data. In the first embodiment of the invention, the user's workspace data is viewed within the kOS application, but it is also contemplated that the data may be stored in various locations. For example, the workspace data may be stored using cloud-based storage.

With the kOS application running on a computer, the user is able to transfer digital media objects from a digital source such as the computer being used to the Home Space. For example, the user may select the media object file from a file directory (e.g., Finder window for MacOS or Explorer window for Microsoft Windows) using an Open File command from within the kOS application or dragging and dropping the media object files onto the Home Space of the kOS application. Similarly, the user, whether or not running the kOS application on a tablet acquiring content or a mobile device gathering images, videos or other content, may share such content with the computer.

While the kOS application may use Internet access to access and upload or import content, the kOS application may run with or without an internet connection. That is, the kOS system may be fully functional for its intended purpose when working offline, as may be the case when accessing and analyzing strictly private (non-public) content. In other cases, the kOS application may only provide complete access to a user's workspace when connected to the internet. In other instances, when working offline and then connecting, the kOS application may synchronize storage and send notifications for shared Spaces. For example, it is noted that the kOS application may be particularly beneficial for shared work projects, but computers using the kOS application may not always have an online connection. The system, in such instances, is configured to notify collaborators and synchronize Spaces and storage automatically when online access is restored.

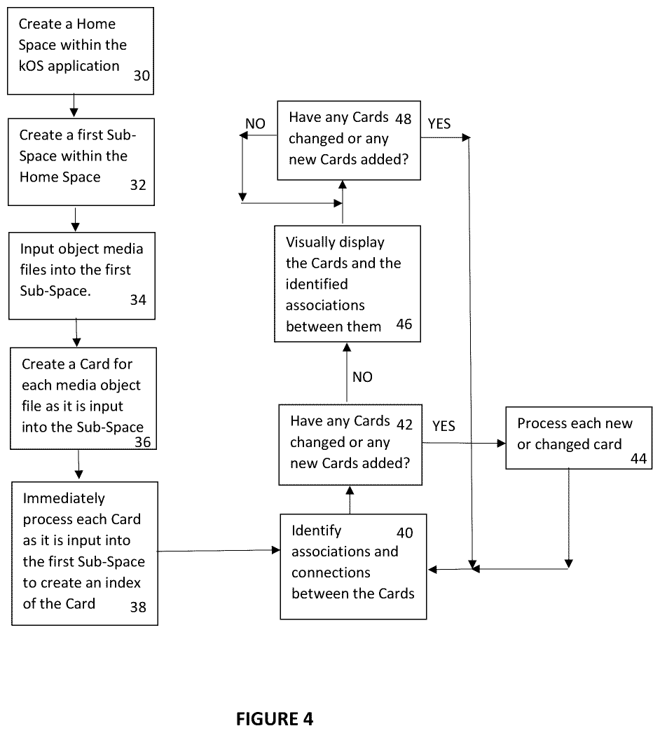

Referring now to FIG. 4, there is shown a flowchart that illustrates and describes a framework of the kOS application. In first step 30 of the framework, the system creates at least one Space (the Home Space) to function as a container for a set of Cards, other Sub-Spaces, or both. The user may create a first Sub-Space within the Home Space in step 32, wherein the Sub Space is going to be a workspace for a first user project. The next step 34 is to input media objects into the Home Space and/or the Sub Space, where text-based media objects, image media objects, audio media objects, video media objects, or any other digital media files or associated metadata are disposed into Text-based Cards, Image Cards, Audio Cards, Video Cards, and the like in step 36. However, it should be understood that data that can be transcribed will be processed in this manner in order to create text or other machine readable code that can be analyzed by the kOS application of the invention.

When any Card is created, it is immediately indexed in step 38. The step of indexing is performed in the background as the file is added to the kOS so that when the Card is added, its content is quickly integrated into and available as part of the indexed information of the kOS application. In addition, for digital media files that contain live, real-time or other current event content, the kOS system may be configured to automatically (if user allowed) update the digital media object by checking for latest versions and reindexing the digital media object if the an update has occurred or if the digital media object has been edited by the system or the user (e.g., the user has added annotations, tags, comments, etc. to the digital media object).

After indexing, the next step 40 is to associate the Card with all the other Cards in that Space. it should be noted that the step 40 of associating may be a background process or a low priority background thread.

Once at least two media object Cards have been created within the Home Space or a Sub-Space, the kOS application may then begin to analyze and identify associations and connections between Cards being stored in the same Space as a background process in step 40. The Cards in the same Space or Cards selected by the user will be analyzed for associations between them. After associations are identified in step 40, the next step is to determine if any Cards have changed or if any new Cards have been added in step 42. If the answer is yes, then each new Card or changed Card is processed by indexing it again in step 44 and the process of analyzing associations is repeated. When analyzing, the kOS system may also be configured to identify and essentially focus on Watched Words. That is, the user may select certain words, phrases or entities for which the system is to find associations (e.g., finding things containing the same words, phrases or entities) across select sets of Cards, similar to clustering. In addition, the user could identify a set of Watched Words so that when new digital media objects are added to the system and any of the Watched Words are indexed, the user is automatically alerted.

However, if the answer in step 42 is no, then a visual display of the Cards and the manner in which they are associated with each other is shown graphically on the display in step 46. The system may then remain in a loop in step 48 wherein any changes in Cards or the addition or subtraction of Cards will cause steps 40 through 48 to be repeated. The kOS application may then repeat step 48 until a change, addition, or subtraction occurs in the Cards of the Space.

Regarding step 46, the kOS application may visualize the identified associations between Cards within the same Space or Cards within multiple Spaces as may be selected by the user. In the case where no Cards and/or no Spaces have been selected by the user, the system by default may be configured to identify associations between all Cards in all Spaces in the system. Above all, it is noted that the kOS application provides a meaningful, unexpected, and novel way to visualize and visually observe, configure, manipulate, transform and utilize the associations identified by the kOS application that may exist between digital media objects of various types that have been indexed by the kOS application.

In a second embodiment of the invention, the step of associating data of more than one Card may also include the step of extracting meaningful information and then creating basic information in the form of a bitmap or score. Then when two Cards are evaluated for similarity (the associating process), this can be done in real time. This moves some of the processing away from a slower and thus longer background process to just-in-time type of processing.

When a digital media object is input into a Space, the digital media object is not just stored there. Instead, the user selected and/or system defined or controlled attributes of the Space dictate for one or more actions to immediately take place, with such action or actions repeated for every new digital media object that is input into the Space. Thus, instead of the Space being just a storage location for a digital media object, like a file folder in a conventional operating system directory structure, the Space not only stores the digital media object but processes the digital media object according to certain system and user selected parameters. That is, when the file is uploaded or imported into the kOS application, the file is indexed and analyzed in a background process for associations and connections to all other Cards being stored in the same Space. It should be noted that when the first digital media object is introduced, the digital media object is still indexed. That way, when a second digital media object is introduced into the Space, the new file can be indexed and immediately compared in the background to the first digital media object so as to be analyzed for associations and connections.

The process of indexing each digital media object is more than simple identification of individual words and numbers contained in the digital media object. As each digital media object is indexed by the kOS application, the system also detects and stores common or known word phrases, entities, and other information that may comprise more than a single word, number, or combination thereof. For example, the indexing may identify full names of individuals, addresses, dates, city and state names, geolocations, etc. Once indexing is complete for a particular digital media object, the indexed information is stored as metadata with the associated digital media object from which the indexed metadata was gathered. In addition, for repeat indexed information contained within the digital media object, the kOS application identifies and stores the location of each occurrence, the distance between each occurrence and the number of each occurrence.

As the digital media objects are indexed, the kOS application begins comparing the indexed digital media objects to one another. More specifically, the kOS application begins comparing the indexed metadata created from the indexing, the kOS application may employ a computation of signature algorithm for documents to optimize the computation of associations between documents, which may include content metadata, topics, environmental metadata, and also rely on computations around word density, distance, etc.

Similarly, when a third digital media object is imported or otherwise added to the Space, a Card for that digital media object is created and the Card is indexed. The Card is then analyzed by the system for associations, similarities, commonalities, connections, relationships and/or parallels with the first Card and the second Card. This process repeats itself as each new digital media object file is added to the Space, transformed into a Card and indexed. It may also be repeated if a Card is altered by having material added to it or deleted from it such as through the addition or deletion of annotations or citations by the user. The kOS application is continuously monitoring the status of each Card and the associated digital media object associated therewith to look for any changes, including both additions and subtractions, to the Cards in step 48.

Another feature of the kOS application is the ability of the user to create and add annotations, comments, or tags to any specific Card. These annotations, comments, or tags are then stored with the digital media object as metadata, or they may be stored in the form of separate Cards that include metadata that retains information of the source of the information in the Card, the location of the information within the Card (i.e., an offset into the text or a region of an image) and information about the annotation, comment or tag itself, including the content of the annotation, comment or tag (e.g., notations, color coding, etc.), date of creation, author, etc.). Similarly, the kOS application enables the creation of citations from Cards that are also stored with the original file or as separate Cards. That is, when the user finds information of particular interest within a specific Card, the user may select portions of the Card for later reference or retrieval. For example, the user may highlight portions of a Card that are of particular interest. The highlighted portions are then automatically saved by the system, such as in Notes for Apple Mac users, along with a citation to the digital media object from which it belongs and the location within the digital media object where the highlighted portion is located.

The kOS application may also provide templates for creating annotations so that any annotations created by a user are easily converted or imported into other formats or systems. For example, one template may be provided so that any annotations are formatted for inclusion in presentation slides. Another template may be provided so that any annotations created by the user can be easily printed on index cards. Other templates may be provided to create storyboards, playlists, guided tours, and other interactive forms of creating composite medias for play back, exportation into various video, HTML, or other formats.

Each annotation is capable of spanning more than a single Card. For example, an excerpt can be multipart and multitype, even across digital media objects. That is, the user can annotate an excerpt which is made of text, images, audio and more and that is scattered across multiple documents. In addition, an annotation can combine a variety of properties such as color, tags, commenting threads, and style (e.g., underlined, framed, etc.), and it can also be marked as an entity of some type. When the annotation is generated and saved, such as in Notes as previously described, in Word document, or otherwise exported from the kOS application, the kOS application creates citations to the digital media object(s) from which the annotation applies. The citation includes a =hyperlink with a specific protocol that will automatically launch the kOS application if not already open (or open the kOS window if already running) and display the source content of the digital media object(s) with precision.

An important feature of the kOS application is how the system displays the Cards in predefined visual formats within the Spaces as defined in step 46 so that users can identify and distinguish different types of Cards and the digital media objects they contain. Unlike prior art operating system files that enable files to simply be listed by name or perhaps to show some detail in a thumbnail image, the Cards of the kOS application are more dynamic and display much more useful information. For example, the Cards may include images from the digital media object representative of each of the type of digital media contained within the Card. The user may also be free to modify the visual formats so that Cards are displayed another format that the user finds useful.

Another important feature of the kOS application is how the system displays the Spaces in predefined visual formats or in user defined formats. Unlike prior art file folders that enable files to simply be listed by name, date, file size, etc. and displayed in a list by name or perhaps as a thumbnail image, the Spaces of the of the invention allow for are more dynamic and organic arrangement and display of the Cards as desired by the user.

With this understanding of the framework of the kOS application, then the first step of the kOS application is to provide the user with a first Space to which a new user can add content, add Sub-Spaces, and begin analyzing the content added thereto. The root directory or first Space of the user is referred to as a Home Space. The user may then create a plurality of other Spaces (i.e., Sub-Spaces) within the Home Space. The user is free to organize these Sub-Spaces as desired. However, regardless of the arrangement of Cards, whether in the Home Space or any Sub-Spaces the user is able to compare any Card from any Space as the user so choses so long as the user has access to all such Cards. For example, if a user is working in a collaborative mode with other users where certain Cards are only accessible on a commonly shared cloud-based storage system, then of course, the user would only have the ability to compare Cards on the cloud if the user had cloud access to those Cards.

As may be determined from the descriptions of the Home Space and Sub-Spaces above, not all Spaces are created equally. That is, the attributes or functions of various Spaces may be different from each other. For example, the topmost Space is the Home Space. One or more additional Spaces (i.e., Sub-Spaces) may then be created within the Home Space. The user may then go into a particular Sub-Space or the Home Space and deposit Cards therein. The user may also create more Sub-Spaces within each Sub-Space. This process may be repeated as desired and in some respects is analogous to the file/folder hierarchical directory structure of the prior art. Unlike prior art hierarchical directory structures, however, certain Cards or Sub-Spaces could be given more prominence, weight, or other attributes without moving the Card or Sub-Space to another Space. For example, one Card or one Sub-Space containing specific Cards regardless of its location within the arrangement of Sub-Spaces could be selected as being the dominant Card or Sub-Space with all other comparisons made against that one Card or Cards within that one Sub-Space.

Furthermore, each Space may be characterized as a “type” of Space having certain predefined characteristics and contain Cards having such characteristics or to which such characteristics are to be applied. For example, the different types of Spaces that currently exist in the first embodiment of the kOS application include, but should not be considered to be limited to, Smart Space, Uncategorized Space, and Watch Folder Space. However, it should be understood that any other types of Spaces that may be defined will fall within the scope of the embodiments of the invention.

The different types of Spaces may be used for different types of projects. For example, the Smart Space may be a container that holds Cards or other Sub Spaces that include digital media objects that automatically and dynamically conform to a predetermined query or other criterion. It should be noted that such Smart spaces may be created by the user based on some criteria, or that may be created by the kOS application (e.g. topic clustering) and suggested to the user, possibly for validation.

A Smart Space may also be a Space where any Card that is created with the Smart Space will be tagged with the metadata from the Space itself. In that way the repetitive task of applying user tags is eliminated.

Smart Spaces may also serve as a drop target hotspot where digital media objects, hyperlinks, etc. may be “dropped” into the Space and they will then automatically inherit metadata from the Smart Space itself. Additionally, dropped digital media objects could be processed in different ways for different recipients, e.g., converted to the most appropriate format and sent via the most appropriate channel for each recipient individually. The Smart Space can be smart in at least one of two ways, and any Space can activate any of these smart capabilities, or all of them. The first capability is to define its set of elements based on some criteria, as well as an exception list to include or exclude specific elements (which could be one of the criteria that define a more complex criterion). The second capability is to trigger some action on any element that is added to the space, and some other action on any element that is removed from the space. This could include tagging or other actions, (e.g., converting a document to a different format, broadcasting the document to multiple recipients, compositing the document with other previously dropped documents, etc.).

The user may also be able to create a Space for Uncategorized Cards. An Uncategorized Space is a container that holds Cards which are a “catch-all” for the user (e.g., a work-in-process folder). Cards in an Uncategorized Space, while indexed (which indexing is on by default but may be turned off if desired), may be held in the Uncategorized Space and used essentially as a staging area for the user to collect information to be placed into another Space, Spaces or Sub-Space at a later time before the Cards in the Uncategorized Space are analyzed for associations and connections with other Cards in the system.

Another type of Space that the user may create is the Watch Folder Space. The Watch Folder Space may duplicate any folder that is controlled by the operating system (e.g., a desktop folder/subfolder) on the computer that is running the kOS application. Similarly, a Watch File may be used to duplicate any other file.

The Watch Folder Space is thus a container that monitors a desktop or subfolder and all the files within them that are accessible from the O/S of a computer. The folder being monitored may be a local folder, on a network drive, or on a cloud based drive that is accessible to the user on the computer. The Watch Folder Space may organize information and display media objects as Cards in any of the rendering types.

The intent of the first embodiment is to allow the “best of breed” applications to operate on a file outside of the kOS application, and to then have the changes be duplicated within the kOS application. For example, a video editor may remove part of a stream within a file. When it is saved, the kOS application may receive a notification from the OS and it will update the Card containing the file. For example, this may be implemented by comparing the last modified date of a document with the last visited date of the set.

The kOS application may notify the user of any changes or updates to the Watch Folder Space. When a media object file is stored in a monitored folder in the regular OS, it is immediately copied to the Watch Folder Space. Depending on the attributes of the Watch Folder Space, processing may or may not immediately occur. The Watch Folder Space may also function as a waiting Space until the user moves it to a desired Space. There may also be multiple Watch Folder Spaces set up by the user.

As such, as files within the Watch Folder Space are updated or modified outside the system, the user is alerted and can selectively authorize the system to update and reindex any updated digital media objects.

What should be understood about all Spaces is that in the first embodiment of the invention, all Spaces may include metadata and may have metadata requirements. Metadata may be different for each Space and may be used to manage the contents of the Space and for processing and rendering.

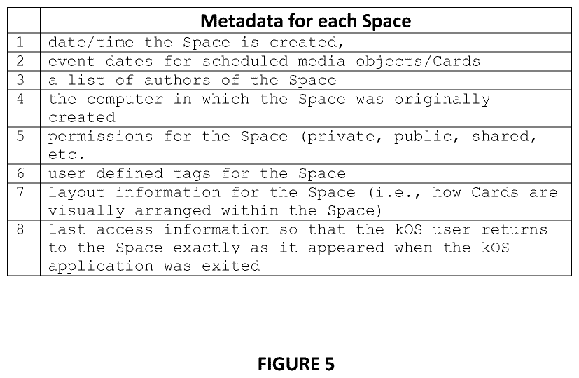

As shown in FIG. 5, the minimum metadata for each Space may include: 1) date/time the Space is created, 2) event dates for scheduled media objects/Cards, 3) a list of authors of the Space, 4) the computer in which the Space was originally created, 5) permissions for the Space (private, public, shared, etc.), 6) user defined tags for the Space, 7) layout information for the Space (i.e., how Cards are visually arranged within the Space), and 8) last access information so that the kOS user returns to the Space exactly as it appeared when the kOS application was exited.

The metadata may further include environmental metadata, such as geographical location where the Space was created or modified, as well as speed, acceleration, orientation, etc. In addition, the metadata may include system and user specified sizes, color, shapes, etc. of displayed objects within visualizations of the objects and information displayed.

While the metadata requirements above may be required for the first embodiment, it should be understood that these specific metadata requirements may be altered without changing the scope of the invention, and therefore may be modified as needed by change, addition, and/or deletion.

Furthermore, to make the kOS application usable as a prepackaged software product/application, the application must maintain information that creates successful usability. Metadata is often used for this purpose, among many others.

For example, the first embodiment may enable a user to create a tag that is implemented as metadata that is to be applied to a set of Cards so that all the Cards would be rendered together in a Category View.

An important aspect of metadata is that users may be able to create their own metadata for a Space which may be referred to as user defined tags. By controlling their own user defined tags, the user may organize and display Cards in Spaces by specific rendering needs. Furthermore, by saving and later accessing the user defined tags, the user has the ability to display the tagged digital media objects, and any sub-digital media objects as a subset that are user defined via the user defined tags.

Any Space may also be used as a drop target for not only Cards, but for documents, files, hyperlinks and other digital content to create Cards containing the such digital content. For Smart Spaces, the Card may inherit the metadata provided by the digital content as well as the metadata of the Smart Space. The kOS application will support the well-known drag/drop feature as defined by the services of the OS of the computer (the platform) as well as by for example selecting the digital media object from a file directory (e.g., Finder window for MacOS or Explorer window for Microsoft Windows), using an open file or import command in the kOS application or dragging and dropping the digital media object onto the Home Space. In any case when adding a digital media object, to the kOS application, the system will automatically duplicate or link the digital media object and any associated or created metadata to the Space in which it has been added. That is, when adding digital media objects and related content to the kOS application, the system may be configured to duplicate the original file(s) before performing the indexing and then separately store the indexed file(s) for retrieval and use by the kOS application.

Cards that are assigned to a Space may be created by the user or the system (i.e., engine). The kOS application may accept text-based digital media objects through a text-based document, a PDF or HTML. The kOS application may also treat all text-based inputs as compound documents that may include text and other embedded digital media objects so that a compound document which includes other media objects (e.g., video, audio, and/or images) may be processed and rendered accordingly.

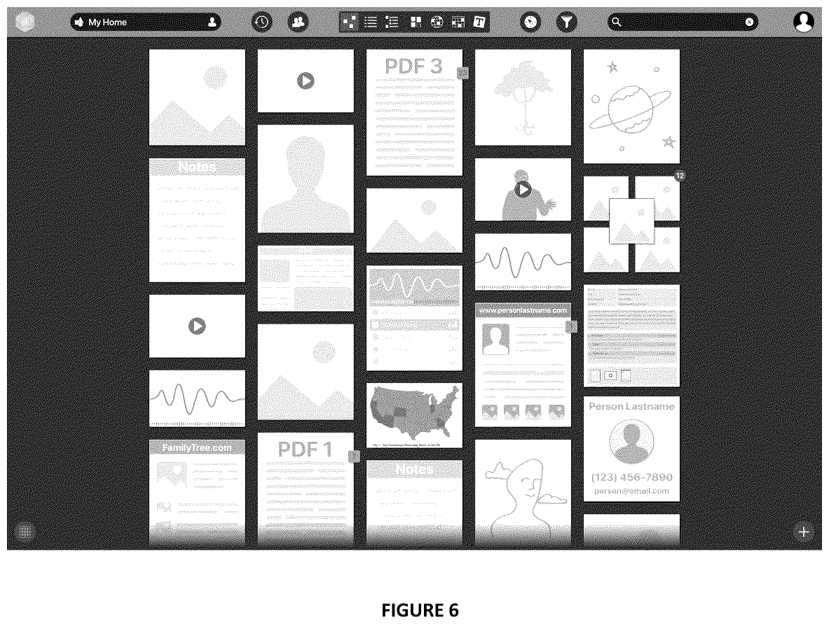

FIG. 6 is another illustration of a Gallery view of a plurality of different Cards that have been placed within a Space by a user. This configuration is similar to those described above but focuses on the gallery, where a subspace can be seen on the right side within the space. Cards of various types can be seen in a mosaic layout: videos, texts, images, sounds, etc. The Cards include Text Cards, Image Cards, Video Cards, Audio Cards, and Composite Cards that may include some combinations of text, images, video, and/or audio.

Cards may be created in a number of ways, such as by dragging and dropping one or more digital media objects onto a Space, by dragging and dropping a URL onto a Space so that the content of that URL is added, and/or by selecting content, such as text from a document, and then dropping the file, URL, or content onto the Space. Computer users are accustomed to different user interface techniques of selecting files and dropping them into a target application, folder, etc. The kOS application will support this and any other well-known techniques for file movement, importation and uploading.

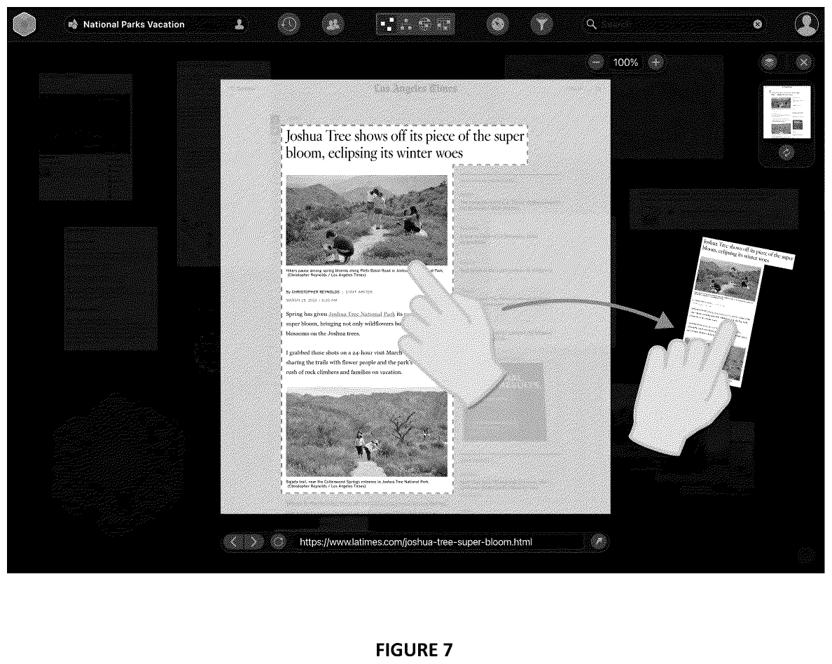

FIG. 7 is an illustration of how text may be selected from a URL and dragged into a Space to create a new Card that includes image data and text data. This illustration shows how the user can create a polygonal selection in a document, such as a PDF file, then drag it to the space to extract it into its own card. The extracted card is still linked to the original document so that it is always possible to go back to the source.

The kOS application will also support the “File, Open” process to create rich text compound document Cards. The kOS application may also open a file to be input into a Card through the file/open Ul mechanism used across all applications.

The kOS application will also support the “Cut & Paste” process to create rich text compound documents Cards. The kOS application will also support creating a Card from text that is in a buffer and waiting to be pasted into a Card or Space.

The kOS application will also support HTML and PDF files as input to create rich text compound documents that may contain text, images, and other media types.

The kOS application will also support creating a Card by just pasting a URL link into a Space. The content at the URL link may be copied into a compound document to create a Card within the Space, and the URL will be maintained within the metadata as the original source.

As mentioned previously, each Card is a container for a digital media object. A Card may contain text including compound documents such as a PDF or webpage (those containing text, images, video etc.), audio, video and images. The text may be a text file, HTML, a PDF or may come from an extracted annotation or citation from another Card. A Card with an image will contain a variety of media file types defined in the Card image section. A Card is an atomic unit of the kOS application that contains the content of the digital media object, metadata to describe the digital media object itself, and any user defined tags/metadata. A card can also be a container for multiple media objects as well, in which case such digital media objects are composited in some user controlled way, each with its own geometry (translation, scale, rotation) as well as other characteristics (opacity, filter, etc.). For example, this is how meme cards can be created.

Thus, the Card/Space metaphor is fundamental to the kOS application and functions as a foundation on which the kOS application is built.

The kOS application may support receiving HTML files from any media as a compound document-based input file. The original file may be represented by the Card and the text of the file may be processed as any other text file that is input to the kOS application.

The kOS application may support receiving a PDF file as a compound document-based input file. The original file may be represented by the Card and the text of the file will be processed as any other text file input.

The kOS application may also support creating a Card by inserting a URL link into a Space. The kOS application may accept a URL (or hyperlink) as a compound document-based type. The kOS application may pull the webpage for the link and create a Card with the document the link represents. The URL may also be saved in the metadata for reference to the original source material. Further, in order for the user to be able to archive and view any websites or webpages offline, the kOS application is configured to create and save a web archive file as may be required to view the web site/web page offline.

The kOS application may also support creating multiple Cards from a single third-party search implemented within the kOS application or by dropping a search-based URL into a Space. The kOS application may also allow an external search engine to provide files for input into Cards. The input of digital media objects into Cards directly from a search engine would be expected based on the OS and/or platform usage. Each Card may include within the metadata the search terms that were used to create the Card, and may also become tags such as user defined metadata for a Processing engine.

The kOS application may also allow an external OS running other applications on the computer to create a search and those results may be input as new individual Cards. Each Card may include within the metadata the search terms that were used to create the Card, and may also become tags (i.e., user defined metadata). Multiple files being input from a search or multiple files dropped into the Space of the kOS application may be expected to create individual Cards based on the OS and/or platform usage. However, as a practical matter, the kOS application may be configure to limit the number of Cards that may be created from such a search because the search results may number in the thousands.

The kOS application may also support creating Cards from a table, CSV file, tab delimited file or spreadsheet. Users are able to input a table into a Space via, for example, drag and drop, by opening a file or by other Card creation mechanisms. Each row of the table/spreadsheet may create an individual Card, with each created Card having the same initial metadata.

The kOS application may also provide other features for manipulating Cards. First, the kOS application may support modifying Cards by the author of the Space or collaborators with appropriate privileges. As a Space is developed, Cards may also be updated as needed by the user, so they must be able to be modified, including the metadata (kOS application generated and user defined), but the original media object will not be updated. Thus, the ability to add, modify, and delete any digital media object in any application may be provided by the kOS application.

Next, the kOS application may also support deleting Cards from a Space by the author or collaborators, if authorized by the user. As a Space is developed, some initial Cards may no longer be needed, and the user may then be able to be remove them from the Space. Alternatively, such Cards may be hidden from view rather than deleted or removed. In other words, Cards may be hidden from view rather than deleted so that such Cards can be later retrieved if desired.

Another feature provided by the kOS application is selecting a Card to be moved, duplicated, or cloned into another Space. Thus, Cards may be copied, cloned, or cut and pasted into other Cards or Spaces as other applications use the capabilities of the OS. The information in the new Card may include all metadata (KOS application generated and user defined) or may be selectively copied without the associated user created metadata that may have been previously added. For example, if a Card has been annotated, the user may choose to copy the Card to another Space without the associated annotations.

The kOS application may also support duplicating and cloning a Card to be included in the same Space or into another Space. Thus, Cards may be replicated for use in the same Space, or another one, to effectively allow cross-shelving of content.

Similarly, a Space may also be copied, moved, and otherwise manipulated in the same manner as a Card.

Each Card may also save metadata for the digital media object. At a minimum, the metadata may include: 1) date/time the Card was created, 2) date/time the original content was accessed, 3) date/time for excerpts, 3A) date/time the Card has been updated, 3B) date/time the original source material was created, 4) date/time for a scheduled event for the Card, 5) the file name of the object, 6) the list of authors of the media object, 7) the author of comments or annotations, 8) the location for the media object which may be extracted from the text or looked up using IP Address lookup service for webpages, 9) the URL (for a webpage) of the object, 10) layout information for placement of the Card within the Space, 11) user defined tags for the Card, 12) a title for the digital media object that is different from the filename, 13) size and rotation of the Card, and/or 14) other environmental data that may be captured (with user consent) so as to be able to create a more complete history of any Card or Space.

While the metadata requirements above may be required for the first embodiment, these specific metadata requirements may be altered without changing the scope of the invention and may be modified as needed.

Another feature of metadata is that the users may be able to create metadata on a sentence, phrase, or word, or any other type of text structure such as chapter, section, paragraph, header, footer, footnote, etc., within the text of a Card. Users typically want to have control over their own tags for organizing Cards within a Space so that it can be organized and displayed according to their specific rendering needs and to create specific associations between Cards within a Space.

The Cards in the Spaces may also be created manually. When the kOS application creates a Space, and Cards are added to the Space it automatically creates entries into a Table of Contents for each Space and each Card that is added to each Space. The user can use the table of contents to navigate through the various Spaces and Cards as wall as through the Spaces and Cards themselves.

Cards may also be imported into a Space. Images may be input by dragging and dropping one or more images into a Space, or by selecting an image from a document, PDF or web page and dropping the image into a Space. These images will become Cards, while the image will retain the source metadata.

The Cards above have mainly been text-based digital media objects. The first embodiment may also include Image Cards generated from digital image media objects. The users of the kOS application may also be able to import image files stored in their mobile device such as a phone. The user selects individual images or may import all of them at once. Each image will retain its source metadata. Users may then enjoy the ease of using the camera on a mobile device to create Image Cards. Users may import complete media libraries contained on their mobile devices, computers or in cloud storage. Thus the imports may not only come from the computer on which the kOS application is running but from mobile devices that can be employed to authorize transfer of a set of image files to the kOS system. Image Cards may also be sourced and subsequently generated from artificial intelligence that is based on queries, descriptions, etc. Additionally, Image Cards may include digital media objects comprising 3D models of various formats and sources.

As previously mentioned, the users may import image files stored in their desktop/laptop computer. The user may be able to select individual images, or to import all of them at once. The image will retain the source metadata.

Likewise, users of the kOS application may also import image files stored in tablet, as well as images found on HTML pages, images found in PDF files, and images found in compound text files. The user may enjoy the ability to select individual images, or to import all of them at once. In any case, the image will retain the source metadata.

A user may also be able to edit an Image Card by the copy, paste, rotate, crop, resize, and flip image commands. Other editing commands may also be used without changing the scope of the invention.

A user may also be able to annotate an Image Card, and have the option to make the annotations become a part of the original Card or to become a new Card.

For each Card that is created by the system, the table of contents is updated, not only with the identification of the Card itself, (e.g., the name of the Image Card), but with indexed content of the Card. For example, at a minimum, if the Image Card contains multiple images or mixed media, each image or different media types might be identified in the table of contents. This is also the case for other digital media objects, such as text, audio and video media. Additionally, other operations and metadata are applied across all media types of the same kind. For example, for each imported audio or video, the system is capable of computing or determining a playback duration. For text, a reading time is calculated and/or a number of pages is determined. Thus, for each type of digital media object, the system creates a particular set of metadata that is common to all similar digital media objects.

As with any other type of Card, a user may be able to cite an Image Card based on the metadata associated with that Image Card that was either provided by the associated image or generated by the kOS application. For example, the citation may include the author, date of creation, geographic location where the image was taken, etc. it is also contemplated that a user may be able to cite to a specific region of an Image Card and not necessarily to the entire image. For example, if the image contains a recognizable face using facial recognition techniques, a landmark building or other information that can be determined from the image, the citation may include, in addition to the citation indicated above regarding the image itself, information regarding the contents of the image itself.

A user may also be able to render any Image Card by user specified rendering types. In addition, a user may also be able to edit or modify an image as necessary to focus the image on the information most relevant to the project. For example, a user may wish to crop the image to eliminate superfluous imagery from the image. Likewise, a user may be able to apply a filter or combination of filters to an image to alter its appearance. In any event, such edits or modifications without affecting the original image, or alternatively, to effectively freeze (i.e., save) the filtered image as the new original image.

A user may also be able to export an Image Card to other users in the Card format or in the original or native format in which the user received the image.

The first embodiment may also include a Contact Card that may store all, some, or none of the following: images (such as pictures of the contact), text fields for numbers, email addresses, and physical addresses, URLs for accounts such as social media, and web profiles. Contact cards may have the functionality and metadata behavior of any other Card. User contacts are a major source of information that many users tend to keep.

For example, a user is able to import contacts stored in a digital address book. Thus, the system has support for CSV (common-separation value) cards and the ability to import and create individualized Cards from contact information. In addition, the system is able to import contact information from Google, Facebook or any other selected source, with the ability to essentially lock them down within the system.

The first embodiment includes the ability to select individual contacts, or to import all of them at once. At the very least, a VCF file may be imported. User contacts may be a major source of information that many users tend to keep.

In the first embodiment, kOS users may be able to select and import contacts from a mobile device, from other kOS users, from a non-kOS user from a mobile device, from shared contacts, or from any other digital source. The first embodiment thus eliminates the need to require users to re-input information to have it behave as a contact.

As previously noted, the first embodiment may also enable users to import contacts from a table that has been imported in CSV or XML. In business cases in particular, it is likely that contact information has been stored in a table format. The first embodiment enables the kOS application to automatically recognize this information as a contact.

Another source of contact information is in a web card. The kOS application may recognize the information as a contact and appropriately import the information. Contact information is often stored on a website, and the kOS application may be able to recognize it.

The kOS application may also recognize contacts from audio, whether captured or imported. Likewise, the kOS application may also import contacts from photo, video, a PDF file, a contact management system (email, Outlook, Android, etc.)

The kOS application may also manipulate contact Cards through dragging and dropping Contact Cards, combining Contact Cards, providing notifications for Contact Cards, sharing Contact Cards, exporting Contact Cards for external sharing, and adding Cards to a Contact Card. If a contact card is shared, users sharing a Contact Card may be notified when the Card has been modified, particularly if other Cards have been associated with it. This is almost another form of messaging, whereby Cards may be sent to another person simply by dragging and dropping cards into that person's contact.

In sharing a contact, a user should be able to create bridges between themselves and other users that makes their lives easier when using the kOS application. However, a potential barrier would be if users could not use this information outside of the kOS application with non-users, so this function may also be provided.

Once a contact has been created or added to the system, the contact becomes a launching point for any communication with the contact. If the user or the contact then identifies a preferred method of communication, all communications can then be directed through broadcast channel. Furthermore, each Contact Card is linked to an actual collaborator so that any modification or annotation made by that person is linked to their detailed contact card, and their entire history of changes can be reviewed and consulted.

The next step of the kOS application is to perform processing of Cards. Processing begins as soon as a new media object is added as a Card to a Space. Processing includes, but should not be considered as limited to, generating a Table of Contents, indexing, associating, and sorting. While this feature may be common to data management systems that are limited to textual data, the first embodiment of the invention is processing any type of digital media object regardless of content.

The kOS application may automatically generate a Table of Contents for all Spaces. When the kOS application creates a Space, it may create entries into a Table of Contents for each Card that is added to the Space. As the kOS application is seeking out connections between information that is presented, one technique for associating information that may be used within a Space is to evaluate a Table of Contents for commonalities.

The Table of Contents for a Space will be auto generated and updated whenever a Card is added or removed from a Space. The kOS application may use the Table to Contents to manage the Cards within the Space. An entry in the Table of Contents may be created for any type of Card as well. Thus, an entry may be generated for images, videos, text, audio, etc.

The Table of Contents for a Space may be updated by the user by selecting content within text and adding it to the Table of Contents so that a link will be created. The kOS application may be able to display the Table of Contents through a button or other user interface component, or it may be auto displayed after performing a particular sequence of actions in the kOS application. The kOS application may also be able to bring up the Table of Contents and link and jump to content within it. Each entry may include a link to bring up the selected Card.

The kOS application may automatically generate a Table of Contents for all Cards created within a Space. As the kOS application inputs raw files, the kOS application may either pull the Table of Contents from a PDF or other file, or use machine learning (ML) or artificial intelligence (AI) techniques to create a Table of Contents for the newly created Card.

The kOS application will seek out connections between information that is presented. One technique for associating information within a Card is to evaluate a Table of Contents for commonalities. This also serves as a foundation for creating outlines.

Since the Table of Contents may be auto generated, the kOS application may allow the user to go back and add entries, make changes, and delete entries in the Table of Contents at any time. For example, the Table of Contents for a Card may be updated by the user by selecting content within the text and adding it to the Table of Contents so that the link will be created.

This document has presented the framework of the kOS application as first creating Spaces within the control of the kOS application, and then explaining the various ways that media objects may be added to those Spaces as Cards. The first step of processing the Cards may be to then create a Table of Contents for each Card.

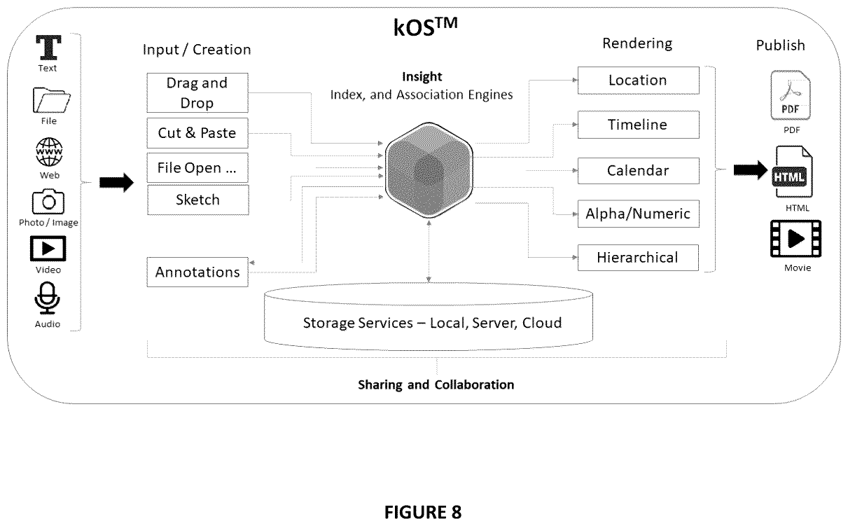

FIG. 8 is a block diagram of the overall framework of the kOS application of the first embodiment. FIG. 8 shows that the kOS application may include several modules or functions. These functions may be defined as input and creation, indexing, associating, sorting, rendering, and publishing. More specifically, the flow begins with acquisition of digital media objects. This might include the creation, importation, or generation of digital media objects. Once acquired, the digital media objects subject to transcription, indexation, and augmentation as necessary. The indexed digital media objects are then subject to association engines of the system so that the digital media objects can be associated, with other digital media objects in the system, organized, and filtered. The filtered digital media objects can then be explored, annotated, produced and published (e.g., shared). While these functions are identified as being performed by the kOS application, it should be understood that these categories necessarily include one or more subcategories that describe other functions, and thus the kOS application is not limited to only these functions.

The first function was generally identified as input and creation. This function of the first embodiment includes both content creation as well as content collection or acquisition. Media objects are created and/or acquired and input into the kOS application. As shown in FIG. 8, the media objects may include media in any format, including text, photo, video, audio, digital files, and web content such as web addresses or web pages.

As also shown in FIG. 8, the method of inputting the media object to the kOS application may be through any convenient means including, but not limited to, dragging and dropping complete files, cutting and pasting portions of open files, opening a file from the kOS application, sketching a diagram within the kOS application, creating annotations for an existing media object file and/or sharing from an external application or source.

Digital media objects may be acquired from many different sources including, but not limited to, websites, email, electronic storage devices (e.g., hard drives), cloud servers, online or libraries, podcasts, audiobooks, etc. and may include various types of content including but not limited to articles, from newspapers, journals, magazines, websites, research reports, podcasts, audio streams or files, video streams or files, and user generated content. The information may be from a local source such as local restaurant menus, or from a national or world source such as a television or Internet broadcast, each of which may be digitally downloaded or otherwise digitally extracted from their respective source.

What is important to realize is that there is no limitation to the sources or forms that the digital media objects may take, and that audio and visual data may be just as accessible as textual data. It is also important to recognize that the digital media objects may come from both private and public sources and may be user generated.

As noted above, processing of the Cards begins with generating the Table of Contents as shown in FIG. 3. Subsequently, the kOS application indexes the Cards, and then begins associating, and sorting the Cards relative to one another. While this feature may be common to data management systems that are limited to textual data, the first embodiment of the invention includes indexing any type of digital media object as well as digital media objects containing mixed media.

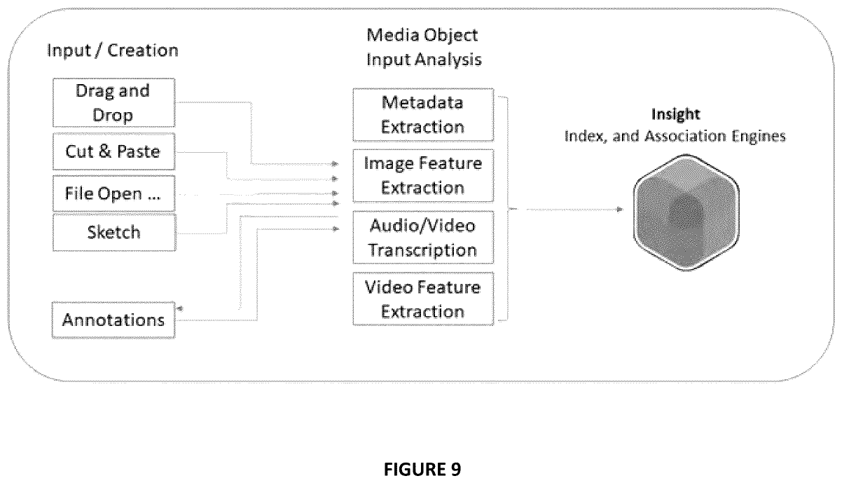

As shown in FIG. 9, the step of indexing may be performed as soon as the media object is delivered to the kOS application and is key to the first embodiment. For the first embodiment to function, processing of the digital media object is critical and is not limited to text. Some non-text digital media objects may be indexed by first applying additional processing technologies to transcribe, extract or enhance the digital media object into a form in which makes them more easily accessible to an indexing engine.

Thus, the first embodiment extracts content by transcribing all audio media and visual media that has audio data in order to obtain words, phrases, entities and metadata. This extraction process is performed using a variety of cognitive technologies including but not limited to parsing, transcription, concept extraction, and feature detection.

FIG. 9 shows that extraction includes the extraction of metadata that may be associated with a media object, audio and video with audio transcription, image feature extraction and video feature extraction.

For example, if the media object is audio data, the audio data may be transcribed into a text file that is then associated and stored with the original media object file. The media object file will then be comprised of an audio file and a text file and may be referred to as a combination file.

If the media object is video data, then extraction may include not only audio transcription if it exists, but also feature extraction. In other words, a textual description of the visual data may also be extracted from video files. Similarly, a textual description of the digital image data may also be extracted from static images.

Ideally, the video and image feature extraction may be performed using an automated process. While initially the extraction may be rudimentary, the ability to improve recognition of video and image features should be considered a feature of the first embodiment.

FIGS. 7 and 8 show that once text or a text description of the digital media object is obtained, the digital media object and associated data are sent to an Indexing and Association engine.

As the kOS application inputs raw digital media objects, the kOS application indexes all text within the content and metadata to create a set of terms, phrases, and entities for the Card. For example, FIG. 3 shows an index of terms that have been created from the content contained within the Cards in the center column of the screen. The kOS application may then seek out connections between information that is presented. The first step is to create a list of information or criteria that will be used to identify these connections. This might include certain identified signatures, etc. that are generated when a digital media object is indexed and using the index signatures of digital media objects to determine the associations, similarities, commonalities, connections, relationships and/or parallels between Cards.

Once the index has been generated and the index connections between Cards have been determined, the user will be able to view words, phrases, entities and other select terms for a selected Card or Cards from the comparative index results as a list and/or a word cloud as shown in FIG. 3. When a word, phrase, entity or other term is clicked/selected the system displays a list of occurrences that may be sorted, grouped by document or chapter, etc. The user can then select to view each occurrence in the context of its enclosing sentence or snippet of text and decide to click on it to view it in the context of the full document, jumping to the corresponding page and highlighting the sentence as well as the selected term or phrase within. That is, after a word, term or phrase is selected, the snippets or sentences within that document or set of documents surrounding those words, terms, phrases, or sentences are displayed within the context of the document.

It should be noted, in addition to lists or word clouds, the system may include other types of visualization, such as a word distribution diagrams, density maps, etc.

Advantageously, the kOS application may automatically associate all Cards within a Space by evaluating the indexes for each Card and comparing them with every other Card within the Space and scoring the interaction between each Card. Indexes/scores that either match or have a significant score between Cards will create the connections, and the scores determine the strength of the connection. The kOS application seeks out connections between information that is presented, and the metadata contained within the Cards. Alternatively, the kOS application may more efficiently automatically associate all Cards within a Space, by first eliminating common words and phrases from the analysis, such as common articles, prepositions, verbs, pronouns, etc. and focusing (i.e., weighting) on more unique words, phrases and identifying language or terms (e.g., proper names, locations, times, subject matter, etc.).

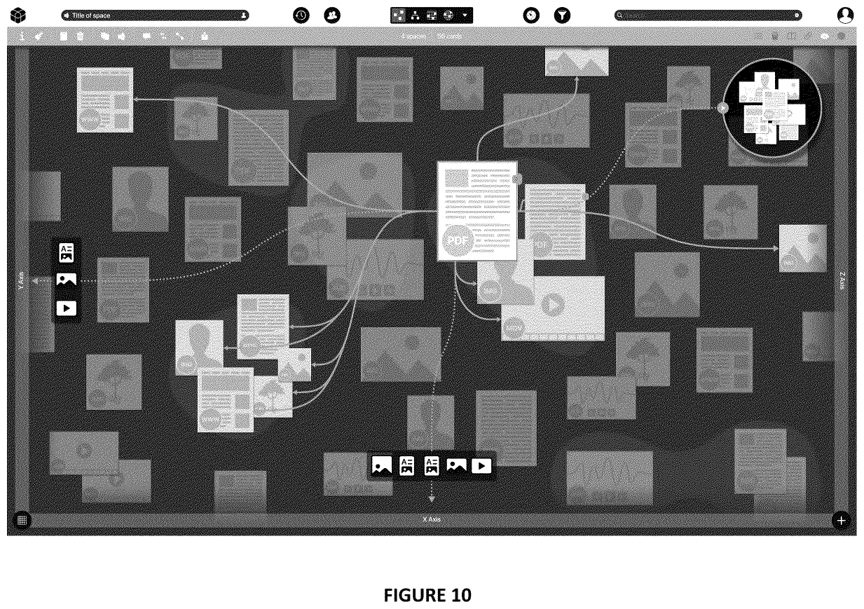

Once associations have been identified, the next step is to display the associations of a selected set of Cards in a Space in a list or other visual format. The list may also show the scores to demonstrate the strength of the connections. The display of weights may be numerical, or through colors, bolding, fonts or other user interface techniques. The scores may also be sorted so that they may be listed in a particular order, such as ascending or descending. The visualization may also be in the form of a word cloud in which words, phrases or entities with higher numbers of common occurrences between Cards are presented in a larger font and more centrally located than less frequently occurring words, phrases or entities. FIG. 10 is an illustration of how associations between Cards may be visually displayed using arrows to show a selected document near the center of the display, and all documents that are associated with it are indicated by arrows. This embodiment shows how cards, laid out in a board context, can be interconnected visually as a web of information. Some of the cards connected to the focused card are outside of the visible space, as can be seen by the link ending in the left center of the board. The focused card is also connected to a subspace in the top right corner of the board. This allows the user to see which digital media objects contain common subject matter. Also, by modifying the relative size of digital media objects relative to the selected document, a user might be able to determine which of the other digital media objects may contain more relevant information than others.

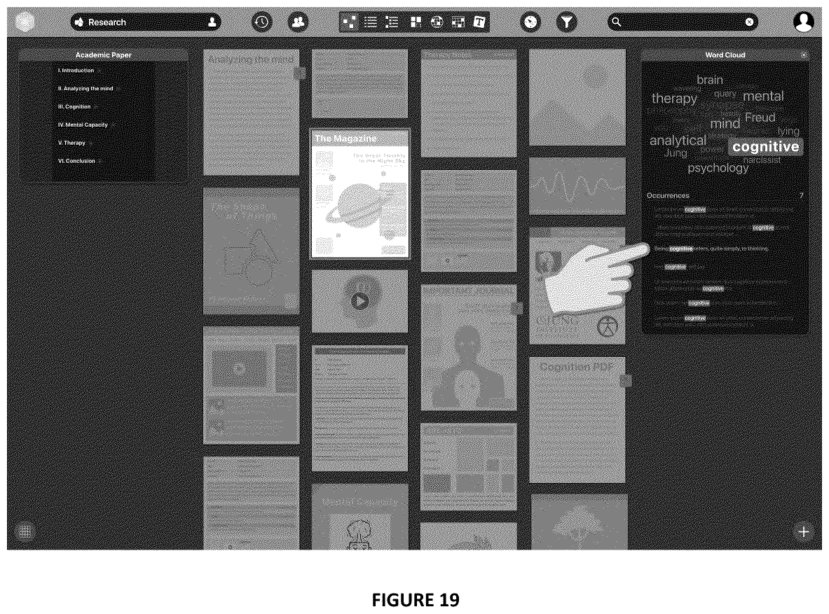

Another powerful way to show associations between a select set of Cards is illustrated in FIG. 19. In the center section, various digital media objects are being compared. In the right column, a word cloud has been generated with various words such as “cognitive” being shown in larger font than others, indicated that the word has more common occurrences in the Cards than other words such as the word “lying”, which is displayed in a relatively smaller font. Further by selecting/clicking on the word “cognitive” and highlighting it, occurrences of the word “cognitive” in the Cards are displayed below the word cloud. By then clicking on one of the occurrences, the Card where the occurrence is located is opened to the location of the occurrence, allowing the user to view where in the Card the word “cognitive” is found.

Additional detail is also useful in describing the function of annotations and citations in the kOS application. First, the kOS application supports excerpting text information or information from any embedded media object in a Card. The kOS application provides a mechanism for selecting a portion of a Card to be copied or commented upon. The selected text can also be shared through social media platforms where the operating system provides connectors to those platforms (i.e., LinkedIn, Twitter, Facebook, YouTube). The kOS application's strength is in sharing and collaboration, so selecting information from a Card for commenting or copying to another Card is a fundamental feature of the first embodiment. The annotations may include not only the ability to create comments, textual annotations and the like, but to highlight and tag certain information. The selected, highlighted, annotated, or tagged text can also be shared with external applications or recipients via applications or communication channels. When shared, the system is capable of tracking all such shares, documenting them, and viewing them as kOS objects, as in a map, calendar, timeline, Card, etc.

The first step is to select some text. Selecting a portion of a Card's information is a key component in commenting, excerpting, highlighting, tagging or annotating. A selection may be made of any portion of a media object including continuous text, discontinuous text, an image, a region of an image, a portion of an audio or video, specific segments of audio or frames of a video, and a region of a compound document. In other words, a selection may be made of text and non-text data. Thus, the kOS application allows any content within a card regardless of the media type (HTML, PDF, image, or video) to be excerpted for commenting/annotating/highlighting/tagging. This includes non-contiguous text and regions to be selectable. Excerpts may be used to annotate or create additional Cards. The kOS application may also provide the ability to collaborate and through excerptions, provide a mechanism to create a dialog between collaborators. Furthermore, the kOS system also annotation of regions that are multidimensional, e.g., a 3D region in a 3D model or space, as well as regions that are made of subregions of different media types, as well as regions that exist across multiple Cards.

It is important to note that the selections and excerpts may be noncontiguous. For example, the selected text or regions for a particular single comment, annotation, highlight or tag may be from several different locations from within the same Card or from different Cards altogether. That is, a single comment, annotation, highlight or tag may refer to more than one location within the same Card or from different Cards altogether. Annotations may also be created that are not selection based but position based, e.g. based on the region of the document that was visible at the time the annotation was made, e.g., based on a certain page as a whole, a double page spread, etc. The region of the document being annotated could also be manually selected by the user (as opposed to selecting actual content, like text). In such cases, one could select a visible area of a page, for example, that could be made of multiple areas, in shapes that are not necessarily rectangular, etc. Such regions could also be operated upon (e.g. cropping, excluding e.g. removing ads, excerpting, etc.). By excluding a region, as by cropping, an effect would be had on the document's index and word cloud, to keep it focused on the content of interest.

Advantageously, the kOS application may retain a position within the information of a Card of excerpted content. This may be useful if the user needs to return to the source of the excerpt for footnoting and original source attribution. Accordingly, excerpts must refer to a specific location within a rich text-based document within a Card. This is for all forms of text including rich text-based document files, PDF files, and HTML pages.

The kOS application also provides a mechanism to make comments/annotations/highlights/tags about selected text within a Card (or another previous annotation). Making comments may be a mechanism for editing, making notations to text, and tracking changes. Making and retaining comments/annotations/highlights/tags are an advantageous function of a collaboration tool for sharing and working as a team.

The kOS application implements this feature by providing a mechanism for annotations to be nested with a Cards' content. This creates a collaboration mechanism for sharing within the thoughts on a single idea based text.

Comments/annotations/highlights/tags may be displayed alongside the original content or in a manner appropriate to the device of the Card in which the annotations occur, such as in a new Card. Annotations, displayed in a list, can also be organized into a hierarchy or multiple ones, as views on the set of notes that can be used for various workflows. Essentially, multiple perspectives on the entire set of notes, with various hierarchies and filters applied, can then be used to produce reports, and other types of work products.

Annotated content may also be shown with the original source material to show how the comments refer to the text. The kOS application shall also provide a mechanism for any selected content within a Card that includes annotations to be copied for reuse in another Card or application. Information may be copied to other Cards and applications, and the annotations may be retained with the text.

Annotations may also be attached to a Card (element) or to the document that the Card refers to. As such, if you have an annotation on a document that is contained within two different Cards, the annotation will appear in both Cards. However, if the annotation is on one of the Cards only, you will only see it in that same document in the context of that \Card alone. Such differences in the display of annotations has particular applicability when cloning Cards, for example.

When annotations are created, the kOS application is also configured to set visibility, comment ability and access level rights to such annotations. For example, the may set annotation access levels to include private (author only), shared/proprietary (defined group of users, possibly via payment, purchase or subscription), or public.

Annotations may also include metadata to ensure the date/time and author of the annotation and other metadata contained in the active Card and Space is retained and may be displayed as a web citation. Thus, basic metadata information must be included so that the annotations have meaning for collaboration. In addition, any form of citation commonly used in academia or defined by the user using text layout, styles, or non-textual media such as thumbnails, sounds, etc. It should also be noted that comments can be made in text, audio, or video form as well. Here again, like any other object, such metadata may include environmental information such as location where the annotation was made, as well as orientation, speed, acceleration, etc.

Lastly, the kOS application may provide the ability for content with a Card to be cited in other Cards, Spaces, or other applications. Thus, a key feature is the ability to locate information and cite that information in other works (including research). Citations may include the metadata of the original source material. The citations are also both static and dynamic in a certain way, where the cited content is updated (or not) or when the original content is changed, depending on user settings, the citations may be dynamically changed to reflect corresponding changes in the cited content.

To use source material as a footnote or other citation, the metadata that describes the origin of the information, text, and date/time the information was created is required for use.

Citations may also be used to keep track of copyrighted material. This may be accomplished by displaying the link to the information if the source material is copyrighted. Otherwise, the full original content of the original source material will be displayed, along with the reference. It is observed that all citations may be considered copyrighted material.

The kOS application may provide a set of tools for searching and identifying associations between Cards within a single Space. First, the user may be able to access a tool to bring up a word cloud of words, phrases and entities for a single Card or user selected Cards within the current Space or any number of Spaces. The user interface may automatically display the word cloud, or it may include a “button” or other toolbar item to bring up the word cloud. The word cloud may use fonts, colors, bold/italics, etc. as user interface techniques to visually show the strength of the words within the word cloud for the selected set of Cards. Identifying the individual items with a Card or Cards within a Space is a fundamental feature of using the kOS application for performing research. In addition, colors may be used to show the distribution of terms (phrases and entities) across documents.

After the word cloud is generated, the user may also be able to search within the word cloud of a Card or Cards for a keyword or phrase. For example, the user interface may include a text box within the word cloud feature, or as an individual tool on the tool bar where the user can input text of a phrase. This input will be used to search the indexes to provide search results. Searching the content of all Cards in a Space is a fundamental feature of using the kOS application for organizing research.

After the search is performed, the kOS application may provide a list view of Cards that meet the search criteria within a Cards or Cards of a Space. For example, the search results may be a list of Cards that contain the search results with the search term (word or phrase) highlighted as a thumbnail in each Card listed. The list view may include the link or hyperlinks to allow the user to link/jump to the text within the Card or Cards for the search results. Thus, the kOS application may also provide the location information within a Card as part of the search terms, phrases and entities.

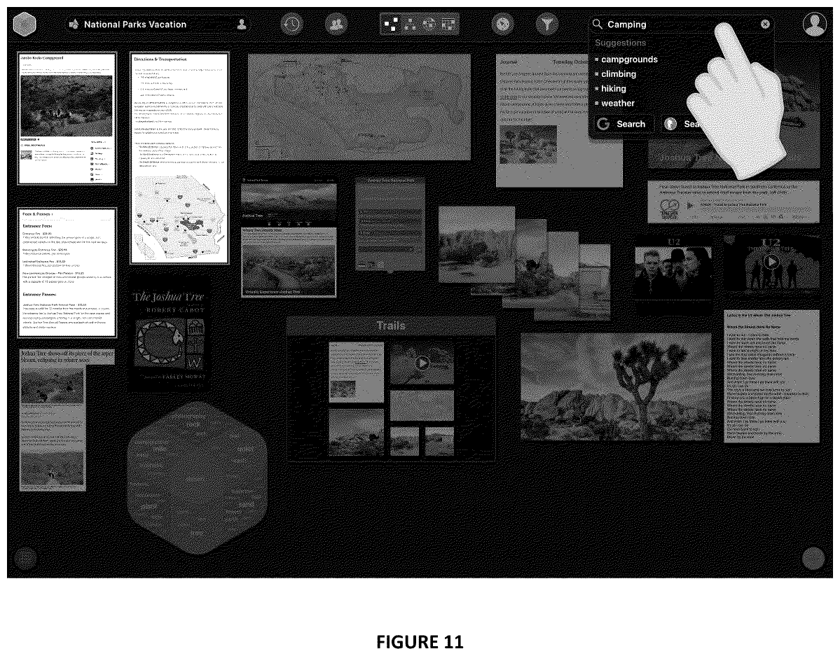

The search results may include hyperlinks to open the original text within the Card in its original form when it was input, and the word or phrase will be highlighted and in view. Selecting a prospective document in the search results may also display the sentence level occurrences in the context of the Table of Contents within the file. To enhance usability, the kOS application may also provide user interface “visual clues” to show the Cards that meet the search results. For example, all the Cards that are in the search results may be highlighted. This may be shown as lines connecting Cards, halos around Cards or some other visual techniques. This feature is illustrated in FIG. 11 where Cards are highlighted with an outline and the content of the Card is not darkened. FIG. 11 shows how a space can be searched and the matching cards and subspaces highlighted to facilitate exploration. A Venn Cloud, i.e. an intersection of word clouds, can be seen in the bottom left corner, as part of the board instead of being isolated in a sidebar tab, which makes the application very versatile as the user can organize and configure cards and views into the same space that can take up the entire screen.

Another tool of the kOS application may be to monitor the underlying content that is stored locally in the computer. Thus, the kOS application may monitor the hard drive or other storage that is accessible through the operating system of the local computer for changes in the original content files that are also stored within the kOS application. The purpose of this activity is to keep the versions of a file(s) held within the file system and as Cards in the kOS application synchronized. By keeping files in synch, the kOS application may be a solution to the problem of numerous file versions. For the kOS application, there are three storage modes when creating or importing content. They include copying, linking, and synching. First, the original file is copied and used for indexing. That way the original file is not corrupted or otherwise damaged during the indexing process. Once indexed, the indexed file is linked to the system wherein the user can verify that the file appears to contain all of the information of the original file. If so, the suer may be given the option to keep or delete the original file. If the user keep the original file and it is one that is subject to be updated over time, the system will continue to monitor the original file for any updates to the original file and then, with user approval sync the linked file to the updated original file. That way the content of the file in the To perform synchronization, the kOS application shall update metadata of the Card containing files that have been changed in the file system. As changes are made to the original content files that are reflected in kOS, metadata will be updated (i.e., the modification date) to track the changes. The kOS application may notify the user of changes in the file-based original content that is updated in kOS. The kOS application may then provide a popup, badges, or other notification to indicate to the user that the original file has been changed, and changes in annotations based on file changes. Moreover, annotations are automatically updated in the case the excerpts that were annotated have been displaced or modified by the changes to the original file.

The display and rendering of Cards are an especially important aspect of the first embodiment of the invention. Since a Space is made up of Cards which are all atomic units containing a media object and metadata (which includes the rendering information), a rendering engine may iterate through each Card and display it as directed by the user. The metadata may thus include a specific display format.

The kOS application may be designed to render Cards in a variety of user selectable formats. These formats may be selected from the group of display formats that include, but should not be considered as limited to, a board view, a calendar, a timeline, by geography, and category by using metadata/tags. These views may be defined by the LATCH principles, wherein the renderings are defined by the following concepts: Location—geographical information for each media object (Card) within the space; Alphanumeric—alphabetical organization; Time-chronologically to create timelines and follow changes in information over a period; Classification-categories of information such as news, music, sports; Hierarchical-hierarchies of information such as how a user may store files within a computer file system.

In the first embodiment, the board view is one in which a user may move cards around a screen as if they are laying face-up on a board. This is a versatile layout that enables the user to place groups of Cards together, stack them, resize them, lay them in rows, columns, or in specific groupings arranged in any desired shape. The board view can not only be arranged manually but also automatically based on templates, formulas, rules, and other instruments defined by the user or provided in a library, so that the board view becomes dynamic.as well as modify their geometry (rotation, scale, and other transforms) and appearance (filters), and also organize them visually in a variety of parameterized layouts.

Another type of view is the gallery view, where all Cards are automatically displayed without overlapping as a series of squares, rectangles, etc. in a scrollable format to display all Cards as shown in FIGS. 1 and 3.

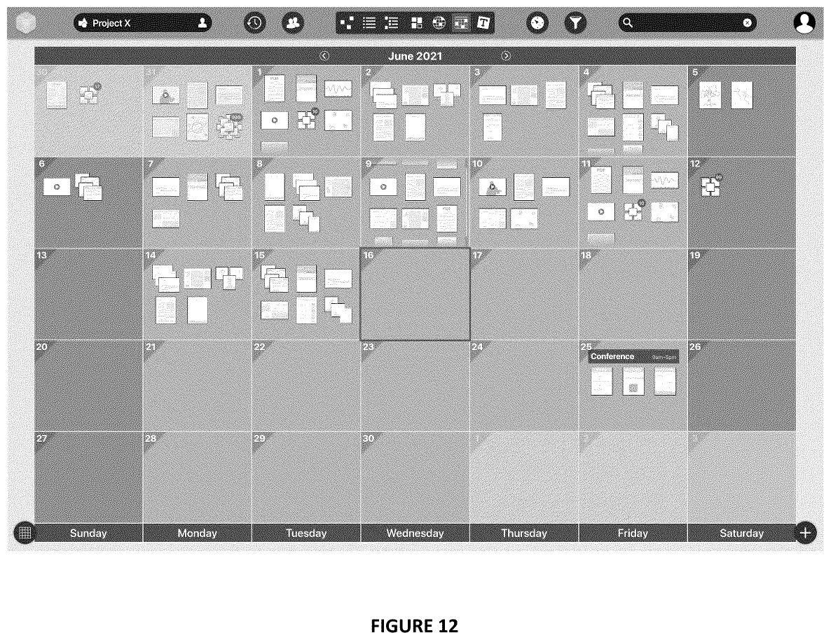

In contrast, as shown in FIG. 12, a calendar view or timeline view employs calendar grouping using chronology as a basis for displaying Cards. The Cards may be placed on a grid style Calendar. In the calendar context, cards and subspaces can be organized in time based on associated metadata. There is an event card type so that events and documents can appear in the calendar, with documents optionally linked to events, which is a great way have access to all the resources needed when going into a meeting, for example. For example, the Cards may be disposed on the calendar based on their creation date, the last modification date, or the scheduling date (one that is in the future). However, these dates should be considered as examples only, and other dates may be used as well. The date selection may be chosen by the user. The default calendar view may be a monthly calendar. The Calendar view may also show dates/times in the future.

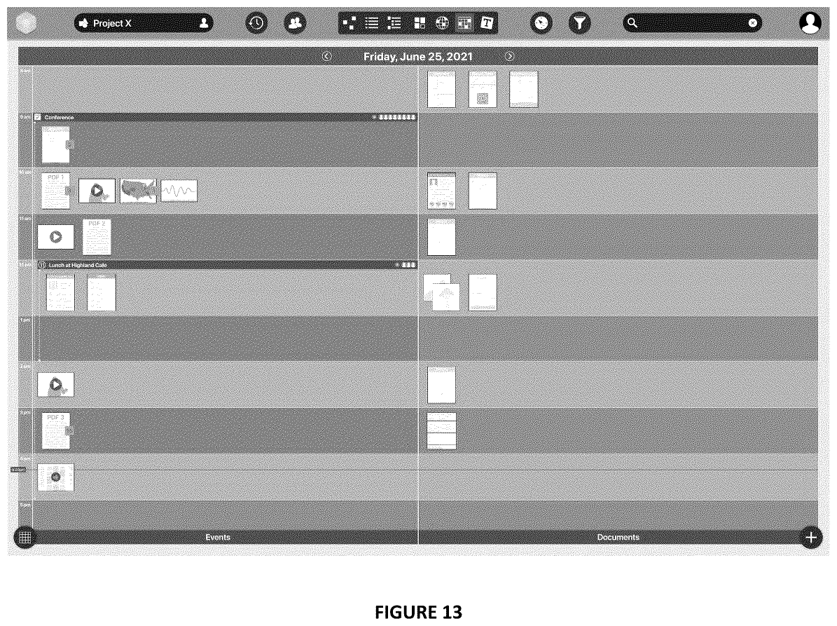

The calendar view may be changed to an annual calendar, or a quarterly, monthly, weekly, or daily view. A specific day, week, or month may be selectable by the user. FIG. 13 is an illustration of a single day calendar view. Here the calendar is focused on a single day, with events separated from documents in two columns. The timeline view is one in which Cards are placed in a linear timeline. Calendar view is highly configurable and is not limited to daily, weekly, monthly, or yearly calendars. Also, the scheduling date is not limited to the future, as the event may have already happened, but is still scheduled at some point.

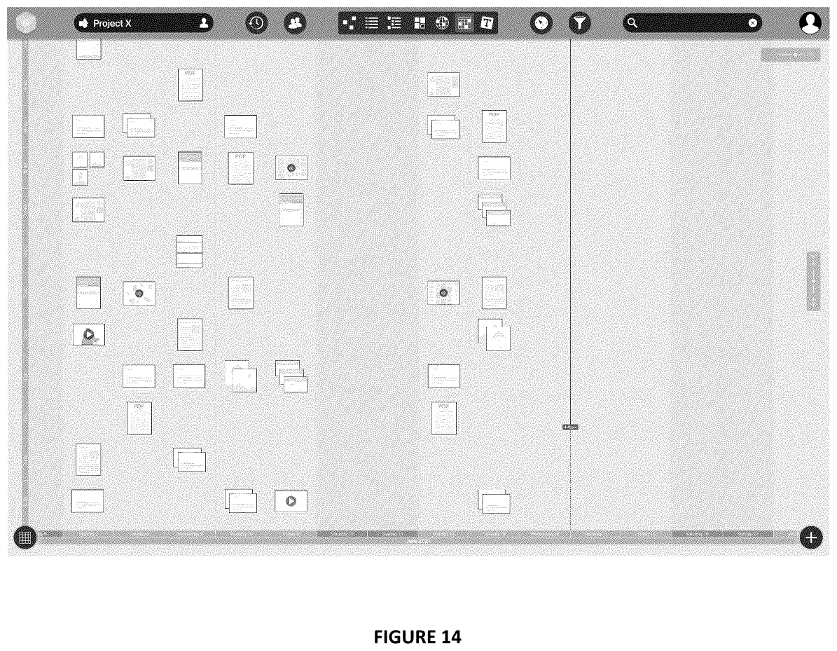

Another possible view is the timeline view of the Cards within a Space as shown in FIG. 14. This embodiment shows the timeline context, where cards and subspaces are laid out based on time, from left to right. Additionally, the user can select any metadata to lay out the cards and subspaces vertically as well, such as document type, document category, and so forth.

For example, the Cards may be placed based on their creation date, the last modification date, or the scheduling date. The timeline view may initially display on a monthly basis and may show dates/times in the future. The timeline view may also be scrolled forward and backward. Thus, the timeline also displays the past, not just the present or future.

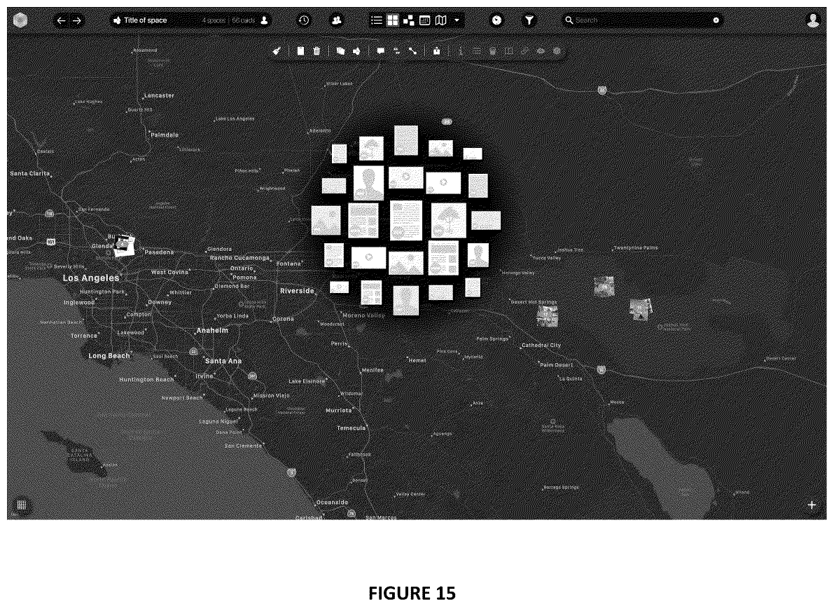

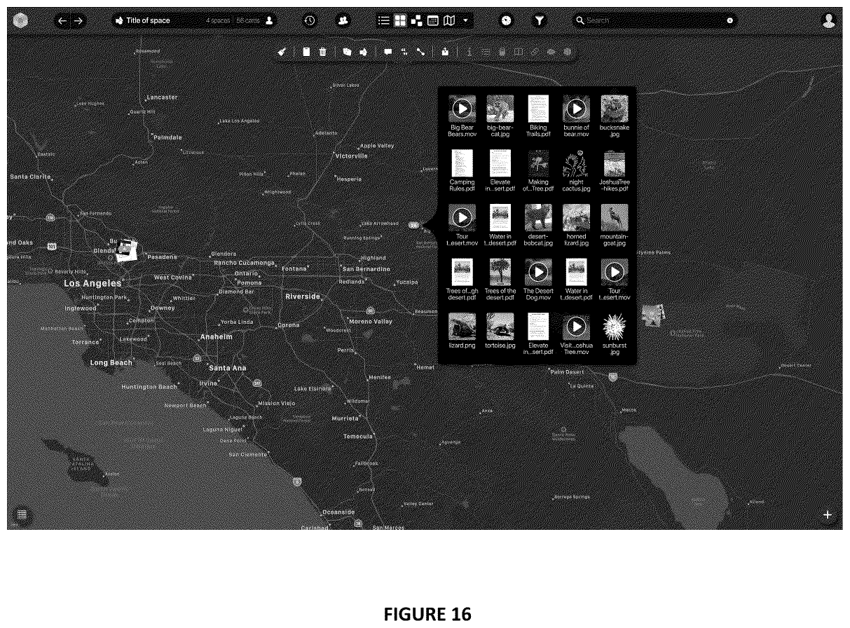

The timeline view may be expanded by more than a month, or down to just a single day using expanding and contracting view controls. The timeline may also be a user selectable timespan that the user may expand and contract within the screen. A geographical view is one in which Cards are placed on a geographic map based on their location information (typically latitude/longitude) such as the display shown in FIGS. 15 and 16. In FIG. 15, a map context is utilized where cards and subspaces appear in various locations related to their metadata. The user has focused on one of the subspaces, which is now expanded to reveal the cards and subspaces within. FIG. 16 shows an alternative way to display the contents of the focused subspace as a grid of cards and subspaces inside a bubble pointing to the subspace's actual location based on relevant metadata.

The geographical view may initially display on a map that zooms in to show all cards as thumbnails on a map. Imaginary geographies are supported as well, such as a map of Middle Earth or even completely abstract geographies that may be rendered in a variety of spaces (Euclidean, Riemannian, etc.) and projections. Also, an image of the genome or schematics of a building, as an example, and more. Generally, any visual representation that can be used as a frame of reference to locate things can be employed.

The geographical view may expand, and contract as needed by the user. When contracting the map, some thumbnails may not be displayed, or they may be clustered together.

The geographical view may also include a mechanism to provide a timeline superimposed on the geographical view. This control shows images on the display over a period of time based on the date/time metadata. The timeline functions as an interactive scrubber allowing the user to view the placement and location of Cards to reflect their appearance as a function of the time registered in the interactive timeline.

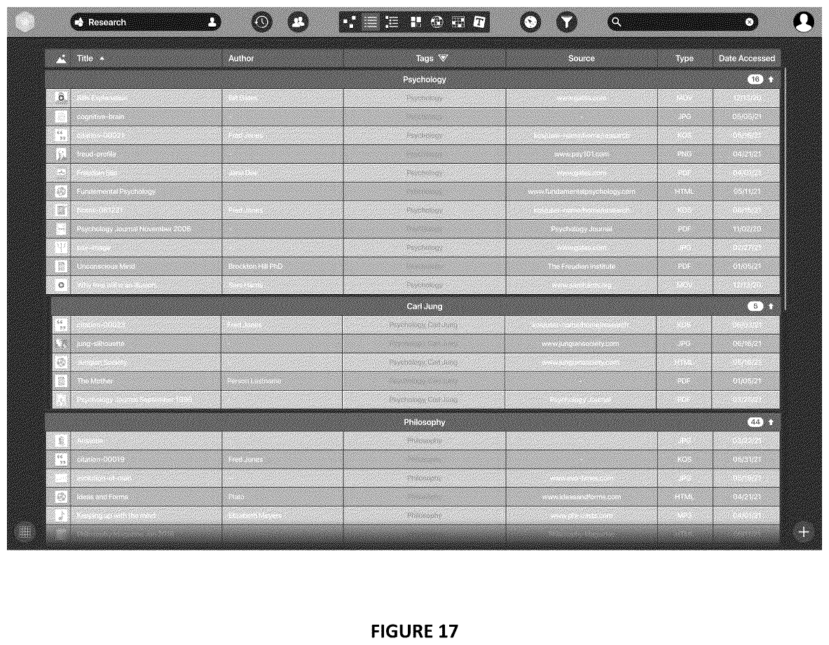

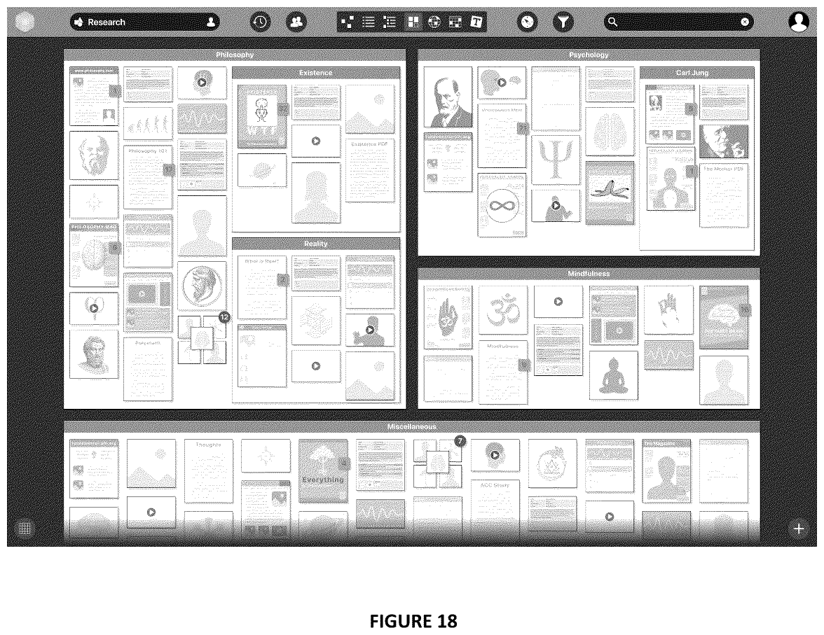

A categorical view is one in which Cards may be placed in a list with columns that correspond to metadata and user created tags (also metadata) and show the hierarchical nature of the Cards within the Home Space or Sub-Spaces such as shown in FIGS. 17 and 18. FIG. 17 illustrates the system in a table context, with cards and subspaces listed vertically in rows, with columns describing their metadata. Not only can column headers be used to sort the table, but they can also be used to break it down in multiple level of hierarchy. In this case, the table is broken down in multiple sections based on how cards and subspaces are tagged. This breakdown could be further refined, for example by breaking down each section is subsections based on time ranges of creation date. Most computer users are accustomed to viewing files and other objects in lists. This rendering view is particularly important to users as determined by user feedback.

The metadata generated by the kOS application, and user generated known as tags or hashtags, may become columns of a list view. The list view may include the name and other metadata/user tags as columns in the rendering display.

In FIG. 18, the system shows how cards and subspaces clustered into a dynamic hierarchy of categories based on how they are tagged. This is similar to FIG. 17 except in a 2D tree rather than a 1D tree.

The user may be able to select the metadata/tags to be shown in the list view. The user may have access to the list of metadata/user generated tags to select which ones shall be shown in the list or categorical view. Thus, the user may also be able to hide metadata/tags from view in the categorical rending view. The kOS application may allow the categorical view to be sorted by user selected metadata/tags. For example, users may be able to click or otherwise select a specific column to sort the list by that specific metadata/user tag in the column. Users expect to be able to have control over the columns they can view in a list.

Moreover, metadata/tags can be used to not only to sort but also to group elements, with primary, secondary, etc. keys to create every possible hierarchy of all elements of a Space in a dynamic and user controlled way (which may also be used in all lists, including the list of notes).

The kOS application may also be able to show multiple views of a single Space simultaneously. Thus, the kOS application may be able display a Space in two or more contexts (rendering types) at the same time. Users may be able to view their Space in different contexts simultaneously to see how Cards fit into different renderings.

Rendering types (contexts) may be exported to represent sets of information in a specific view. This also allows the user to generate unlimited number of views based on the contexts. Within a set or the Home Space, there could be number of different calendar views for personal, work, projects, or travel. Map views could also vary with maps constrained to specific regions, with specific sets of information. The same with Board views. It is also possible to synchronize some of all of the views so that as the one with focus is used to explore, the others adapt in real time to center on the same element that is currently at the center of the focus view. Another type of synchronization would be between views of the same type, so that they would always be centered on the same location albeit at different scale and other view parameters, thus making it possible to simulate a radar view or overview, as an example.

Rendering types may be selected from the group of rendering types including a board view, a calendar, a timeline, by geography, a category by using metadata/tags, charts, and virtual and augmented reality spaces and networks in 1, 2, 3 or more dimensions.

The kOS application may also be able to display two or more different Spaces in the same or different rendering formats simultaneously. Displaying Spaces side by side provides a mechanism to copy and move Cards from one Space to another. The user may be able to select Cards to drag and drop in order to move, copy, duplicate or clone the Cards into other Spaces.

In this case, it may be necessary to utilize a “bucket.” A bucket is a device (a panel in the UX) where items can be dragged temporarily to then adjust the context view and replace them in the appropriate locations. It is also used to display items that do not have the necessary information to place them in the current context, e.g., if an item has no geographical metadata, it cannot be displayed randomly in a map of the Earth. Placing it manually from the bucket actually defines that missing metadata via simple drag and drop.

Similarly, kOS users may be able to click or otherwise select a specific Card or Cards to incorporate the information into other Cards, Spaces or Sub-Spaces.

Users may also be able to export any selected Card, or Cards as a PDF file. If more than one Card is selected, KOS shall create a single PDF containing all selected Cards. Portions of a Space must be able to be exported so they can be reused in research reports, other documents, or as any other supported file type.

Sharing and collaboration are also an important aspect of the first embodiment of the invention. The kOS application may support sharing Spaces and setting permissions. For example, a user may be able to share a Space with colleagues. Shared Spaces may have permissions, to know that an object exists, to see a preview), to view, to discuss, to annotate, to share, to modify, to administer (e.g., delete or reassign).

The kOS application is designed as a collaboration tool, and therefore enables a user to share Cards and set permissions. Shared Cards are the equivalent of sharing an individual document. Permissions are not necessarily limited to Spaces and Cards, however, but also to annotations and other first-class objects of the kOS database. It is about having a very granular way of assigning permissions.

The kOS application may also provide support for invitations that may be sent to others to invite other kOS users to share Spaces. This will include setting the permissions for the Space and its' Cards.

The kOS application may also support notifications for changes performed in shared Spaces. The notifications may be sent to all users of a shared Space in near real-time or batched for those users that are offline. Users must be kept up to date on changes in shared Spaces in order to provide synchronization of shared Spaces. The kOS application may synchronize all changes to a Space to all collaborators of the specific Space in near real-time.

Users must have the most up-to-date Spaces as collaborators work together and therefore must provide synchronization of Spaces between all collaborator's devices. The kOS application may synchronize all changes to all Space to all devices used by a single user. KOS users must have the most up to date information to all their devices.

Storage is an important aspect of the first embodiment of the invention. The kOS application may store all information for Spaces and Cards within the storage system of the user's computer device. The data may be stored locally on hard drives, in user specific cloud-based storage (i.e., the iCloud), or SSDs, or it may be stored using a user's access to online storage such as cloud-based storage.

Since portability of a user's work may be an important aspect of the invention, if the storage for the kOS application is in the Cloud, then a user may easily move from device to device and have complete access to all Spaces and Cards. It should be understood that this use of Cloud storage for the kOS application is still considered “local” storage because it is controlled by the Operating System of the computer.

Accordingly, the kOS application is primarily an application that organizes files and other media objects into Cards that are held within a Space. This information is stored in the users' local device so it can be recalled and displayed to meet the users' needs. Users may expect that creating Spaces/Cards for various projects will be able to reload to review, update and share with others.

Another aspect of the storage is being able to store data in a proprietary format. Thus, the kOS application may use database technology to store the data and metadata for each Card and Space. The database may be able to be exported for sharing and will be expandable as needed by future product requirements.

In the first embodiment of the invention, the kOS application may use the users' Apple® iCloud™ services for storage as it serves as a suitable mechanism for sharing databases between applications within a suite.

The kOS application may also be designed to be capable of storing shared information on the servers of other third-party cloud storage service providers.

Another aspect of storage is that the kOS application may support sharing Spaces through cloud-based storage. The kOS application may utilize sharing of cloud storage for collaborators as it is specifically designed and positioned as a tool for collaboration, so storage must support sharing.

The kOS application may support permissions for storage systems. Cloud storage must be shared for collaboration and to support read, write, edit and read-only types. Shared storage may include a permission and security regimen so that users feel that sharing Spaces include proper security for their work.

The kOS application may also support notifications for changes in shared Spaces. Changes to a shared storage may require sending notifications to all users that have been granted access to the shared Space so that all users may be kept up to date on changes in shared Spaces.

Similarly, the kOS application may provide synchronization of shared Spaces. The storage system may synchronize Spaces for all collaborators of a shared space in near real-time. Users may have the most up-to-date Spaces as collaborators in order to work together.

A last aspect of the first embodiment is related to output of the contents of Spaces. While using the kOS application, a user may enter a Space and examine a rendered view of the Cards that have been added to that Space. Furthermore, using the tools of the kOS application, the user may have identified associations and connections between the Cards using the tools of first embodiment. For example, a word cloud of words and phrases may have been used to identify associations between Cards. Furthermore, the weight of these different connections may also be viewed in a list or other visual display. In addition, the associations may be rendered using various visual formats including boards, timelines, calendars, geography, and by selected categories. However, the kOS application may not be available to someone that wishes to see the results. Accordingly, another aspect of the invention is the ability to publish.

Publishing starts with the ability to share any visual state of Space with oneself or others via bookmarks and guided tours for oneself and/or others. In addition, Spaces may be shared with unknown recipients via an information marketplace. The marketplace allows the possibility of restricted promotion of Spaces through free or paid transactions, the latter being based on one-time or recurrent fees, i.e. purchase or subscription.

As previously described, FIG. 19 is an illustration of an example of a plurality of Cards in a Space, with a single Card selected, and then a word cloud associated with the selected Card. The word cloud is generated for the focused document, with a list of occurrences for some selected concept. A word has been selected from the word cloud, and all of the instances of the use of that word in the selected Card are shown below the word cloud. It is noted that the word cloud may weight the occurrences of words in the selected Card by displaying words in larger letters when they occur more often and with smaller letters when they occur less frequently in the Card.

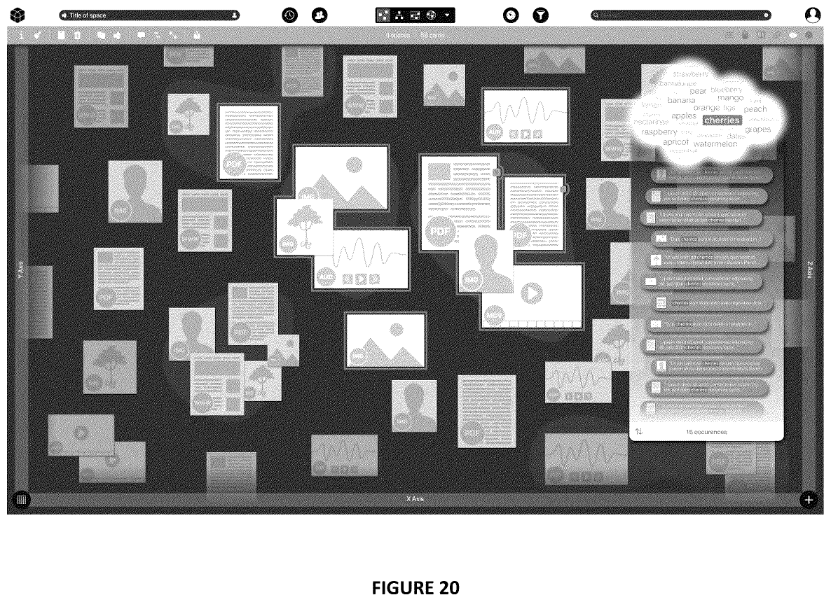

FIG. 20 is an illustration of an example of a plurality of Cards in a Space, but with several Cards selected. This contemplated design shows a space in the board context, with the word cloud and list of occurrences represented in a fancier style that floats above the space. Here, a word has been selected from the word cloud, and all of the instances of the use of that word in the selected Cards are shown below the word cloud. It is noted that the word cloud may weigh the occurrences of words in the selected Cards by displaying words in larger letters when they occur more often and with smaller letters when they occur less frequently in the Cards.

The density of occurrences is also taken into account. For example, occurrences are listed by table of contents, but the system is capable of providing visualizations of the pages or chapters in a document where certain concepts are more heavily used, e.g., distribution diagrams.

It may also be an aspect of the invention that a self-contained mini version of the kOS application might also be bundled with data so that a user may see the results but not be capable of making changes or altering any aspect of the resulting data. Finally, referring now to the thirty application windows, labeled kos01-kos30, showing actual representative windows of the kOS application running on an Apple Mac computer, certain digital media objects in the form of a number of PDF documents have been added to the kOS application. These digital media objects include ©ontent by Cory Doctoro.pdf, ©ontent. by Cory Doctoro.pdf, Earth 2020 An Insider_s Guide to Rapidly Changing Planet.pdf, Introduction to Antrhopology.pdf and Lessig, Lawrence. The Future of Ideas—The fate of the Commons in a Connected World.pdf. As previously discussed, as each such digital media object (in this case a PDF document) is uploaded to the kOS application and converted to a Card, the digital media object and its contents are being indexed in a number of ways and, when indexing is complete, the Card becomes accessible by the user for viewing its contents, for example.

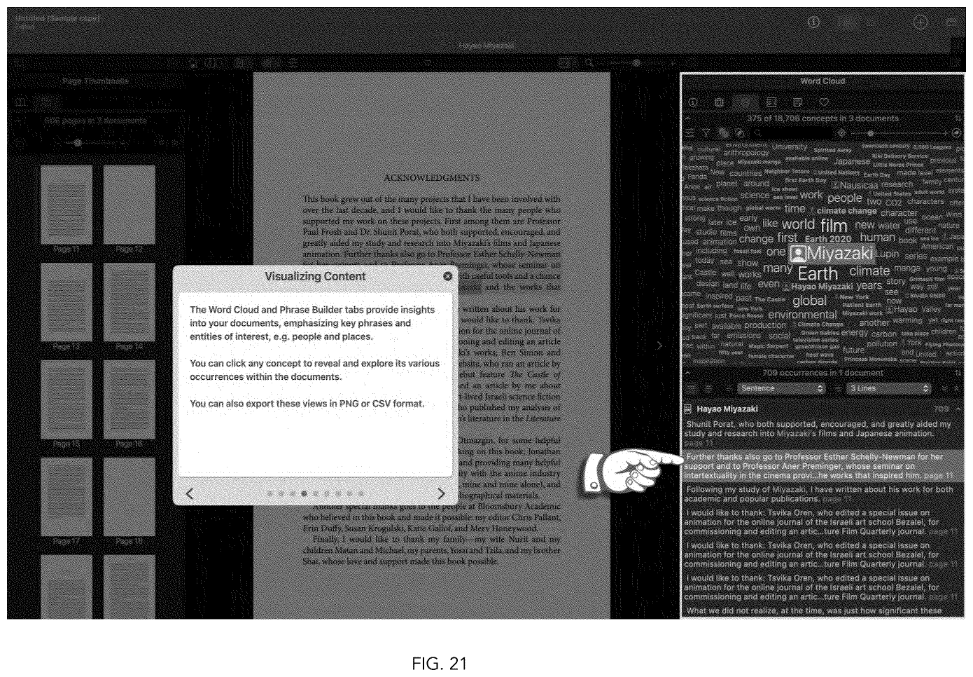

FIG. 21 illustrates a quick tour is presented upon first launch of the kOS application. Each core feature is highlighted (in this case with a yellow frame), with a specific focus on some object (in this case using a pointing hand), and that feature is explained as well (in this case with text displayed in a floating yellow window, though audio or video could be used as well).

The user can then go to the next step or the previous step, or just exit the quick tour. In this implementation, the yellow color is used to represent anything related to help. Also, any part of the user interface that is not related to the current step's explanation is dimmed (in this case, by darkening it).

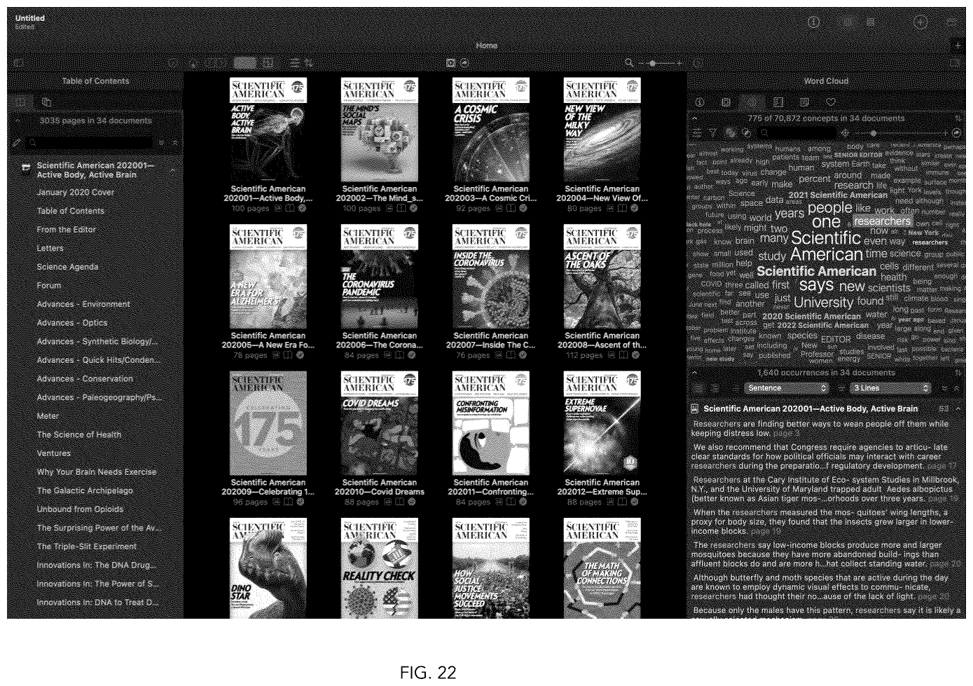

In FIG. 22, users can create any number of projects, each based on its own kBase, which is essentially a collection of documents with notes and much more. Each kBase appears in its own window. All the documents imported into a kBase are displayed in a context view (in this case, a gallery of cover pages, though the documents could instead be represented in a table, timeline, calendar, map, board, and so forth). A kBase window is made of several key components: the toolbar at the top, the sidebars on the left and on the right, and the context in the center, which typically occupies most of the window's space. Upon opening one or more documents, the context is replaced with their content so that it can be annotated and more (as can be seen on another screenshot). The toolbar at the top consists of a main toolbar, a tab bar, and a selection toolbar. The main toolbar is always visible and contains various general functions, such as a way to obtain detailed information about the kBase and a way to import documents into the kBase. There is also a selector to switch between any number of available contexts (in this case, only the gallery and the table are available). The tab bar makes it possible to open multiple views on the kBase simultaneously, just like a browser makes it possible to open multiple views on the Web by creating one tab per web page.

The selection toolbar makes it possible to show or hide sidebars independently, or to change their width between minimized and maximized. Between the sidebars, the selection toolbar contains widgets to control the context, such as switching between grid and mosaic view in the gallery or adjusting the context scale, as well as widgets to perform operations on a selection of documents. When content is displayed, the selection toolbar contains widgets to control the content, such as adjusting the display parameters of a PDF document, as well as widgets to perform operations on the content.

The sidebars contains tabs that can be reordered or even moved across sidebars. Any sidebar tab can also be detached into a floating palette that can be moved and resized (as can be seen on another screenshot). There are eight sidebar tabs featured here: in the left sidebar, table of contents and page thumbnails; in the right sidebar, properties, artificial intelligence (“AI”) chats, word cloud, phrase builder, notes, and favorites.

Each sidebar tab features a mini toolbar at the top to control that tab, such as a search box to filter its contents, buttons to fully expand or collapse its contents, etc., or to perform operations on that tab's content, such as exporting it in PNG format, etc.

The table of contents tab and the word cloud tab are active here. The table of contents displays a navigable combined table of contents for all selected documents in the context, or all documents if none are selected. The table of contents can be edited if desired (in this case, by clicking the pencil button to enter editing mode). The word cloud can ne navigated via panning and zooming, and it can be filtered and configured in multiple ways. Clicking a term, phrase (sequence of terms), or entity (person, place, organization, etc., as identified via icons), displays the list of occurrences of that term, phrase, or entity in the documents selected in the context. Occurrences can be displayed as full sentences or snippets, and clicking any occurrence opens the corresponding document to show where the occurrence exists.

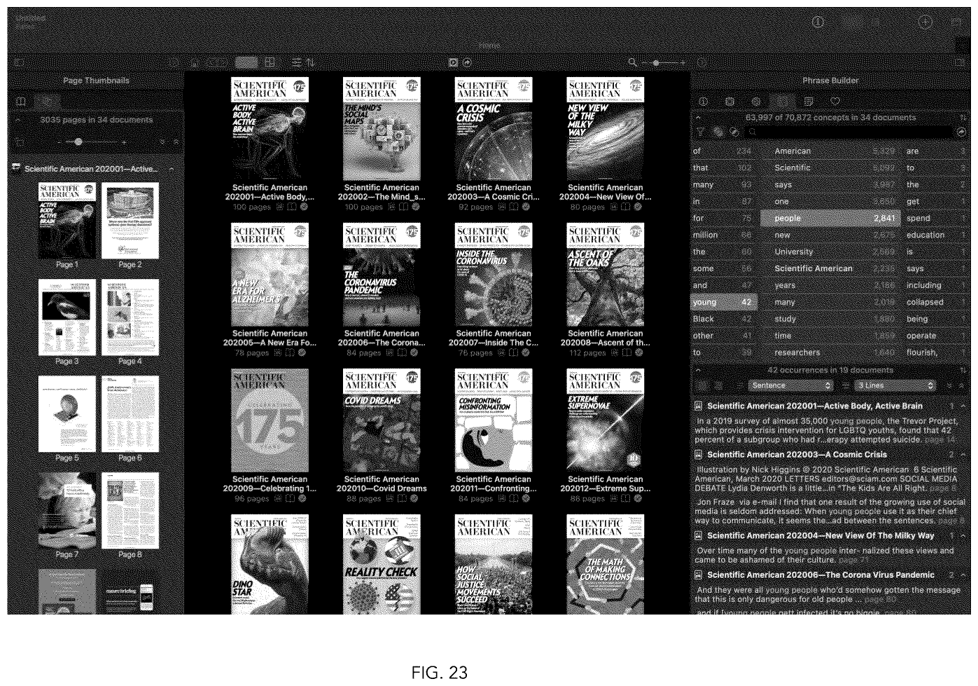

As illustrated in FIG. 23, page thumbnails and phrase builder tabs are active here. The page thumbnails are also combined for the selected documents or all documents, just like the table of contents, and they are organized in a grid with any number of columns (in this case, only two). Page thumbnails can even be collated in pairs when documents are double-sided. The phrase builder is organized in three columns, with the central column containing the list of all terms, phrases, and entities that appear in the selected documents. Selecting a term, phrase, or entity works just like in the word cloud, i.e. the list of corresponding occurrences is displayed, and so forth.

When a term, phrase, or entity (all known as simply concepts) is selected, the left column displays the list of terms that appear before in the content, known simply as prefixes, and the right column displays the list of terms that appear after in the content, known as suffixes. Selecting a prefix and/or a suffix extends the central concept to a phrase or a longer phrase if it was already a phrase, and the list of occurrences is reduced to list only the matching occurrences. Numeric counts are also given for each concept, prefix, or suffix.

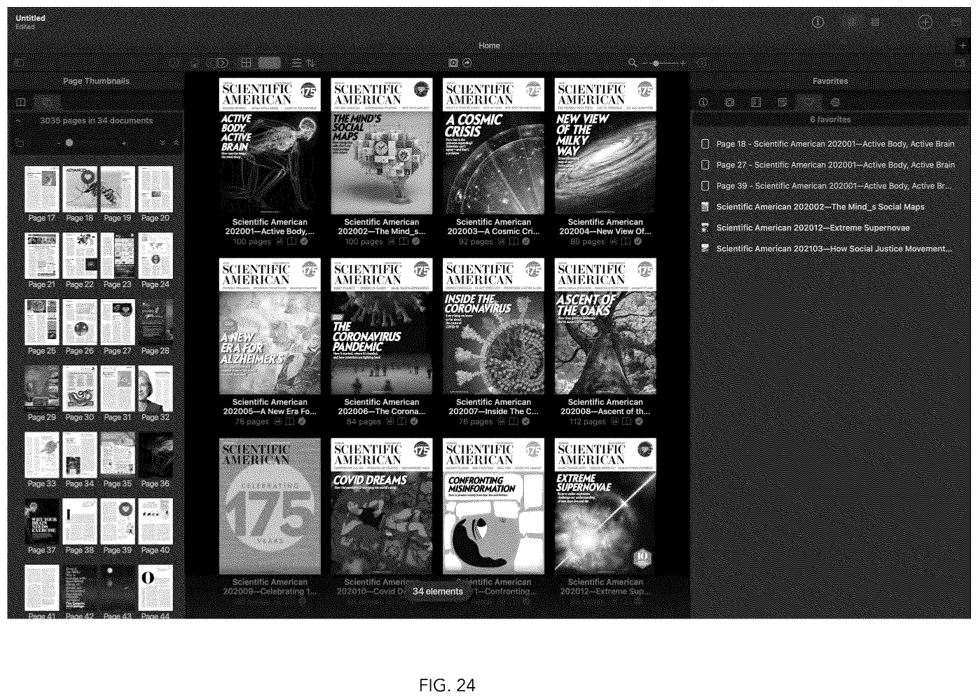

As shown in FIG. 24, page thumbnails and favorites tabs are active here. The page thumbnails have been resized to show four columns instead of just two. The favorites include a list of pages and documents for easy ulterior access. Any kOS object can be favorited, including a page, a chapter, a document, a note, and more.

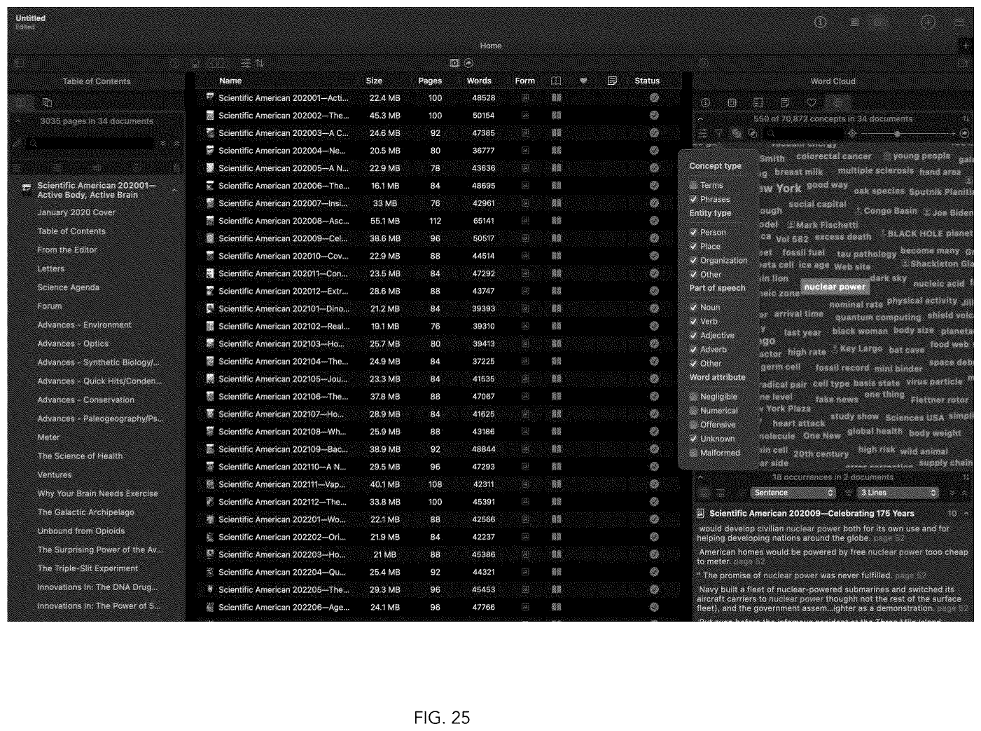

In FIG. 25, a context has been switched to a table to make it easier to see more properties of documents in one view. Property columns can be show, hidden, reordered, and used to sort the list of documents.

The table of contents is in editing mode with an extended mini toolbar making it possible to add or remove a chapter, or to adjust the indentation of a chapter, for instance to make it a subchapter or section. Chapters can also be renamed.

The word cloud has been filtered to show phrase only, thus excluding terms and entities made of a single term. The filter is currently being edited (in this case, all filtering options appear in a temporary bubble that can then be closed, a user interface component that is similarly used throughout the application). Changes made to the filter are immediately reflected in the word cloud tab.

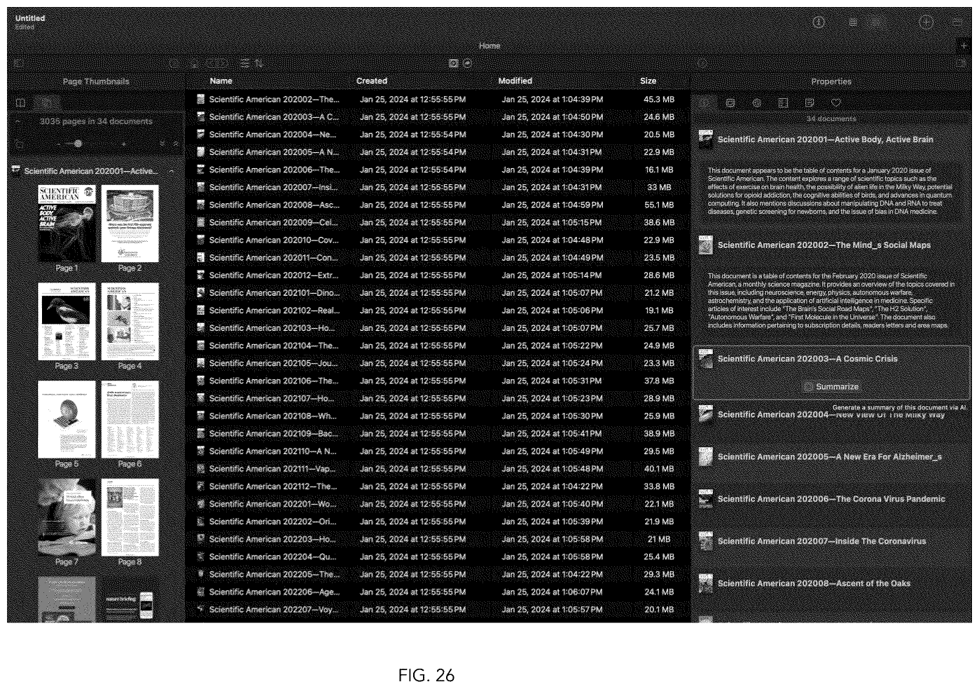

In FIG. 26, a properties tab is active here. Each document is represented in a card with thumbnail, name, and other properties (in this case, other properties are hidden but they would include any property that can be seen in the table context). A document card may also include widgets to perform operations on the document. Here, a summarization button is available and clicking it generates a summary of the document using artificial intelligence. Other operations could include the generation of an image cover for the document, and much more.

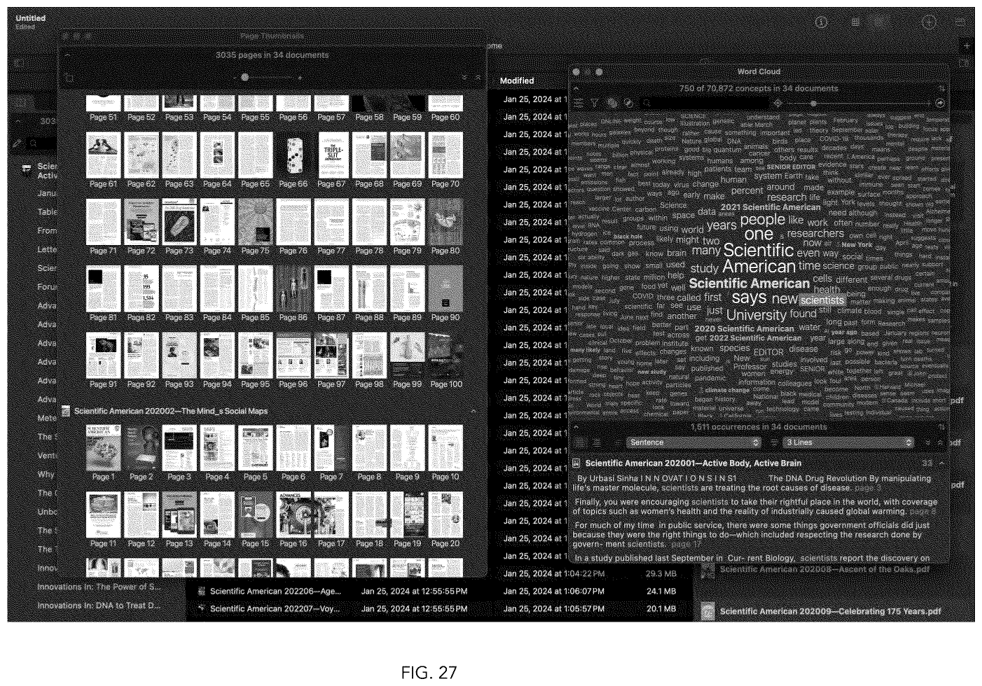

In FIG. 27, page thumbnails and word cloud tabs have been detached into floating palettes that were then moved and resized, thus making it possible to see many more page thumbnails and concepts at once (in this case, space is more limited because the computer is a laptop, but it is easy to see multiple kBases and all sidebar tabs as floating palettes on a large screen). Each floating palette can be maximized to fill the entire screen, making it easy to see entire documents at once to locate certain figures, images, or tables with ease.

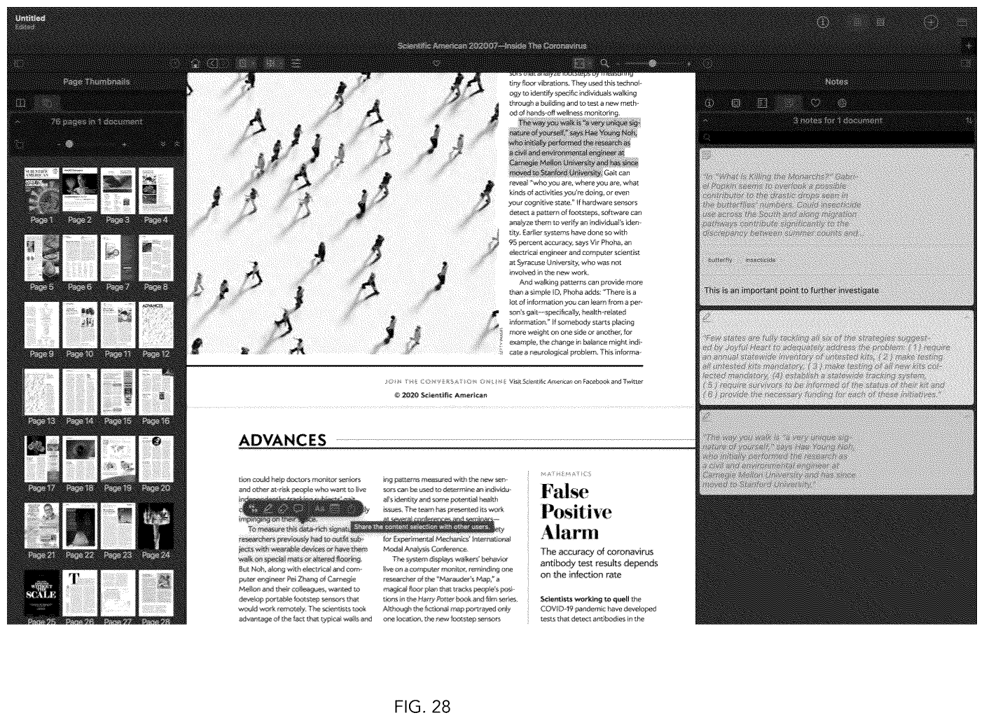

In FIG. 28, a notes tab is active. A document is opened with visible content that features an existing note (in this case, a text excerpt highlighted in green) and a new note in the process of being created (in this case, a text excerpt selected in orange and ready to be annotated). Selecting any content excerpt (in this case, text although it could be an image or any other type of content) displays a set of actions that can be performed on that excerpt (in this case, in the form of icon buttons within a bubble).

Once a note is created, it can be further refined by adding missing note components (in this case, the orange note includes a text excerpt in italics, a orange highlight, the “butterfly” and “insecticide” tags, and a comment.

Actions are divided into two sections: annotation actions and other actions. Annotations actions including excerpting, highlighting, tagging, and commenting, while other actions include defining (in a dictionary, for example) and sharing (in this case, to an external notes application or to any other application).

The notes tab contains a list of three notes so far, of which only one is currently visible in the content. The notes tab supports an unlimited number of notes, though it only displays the notes that correspond to the selected documents in the context, or all documents if no document is selected. The search box in the mini toolbar can be used to filter the notes based on a query applied to all excerpts, tags, and comments.

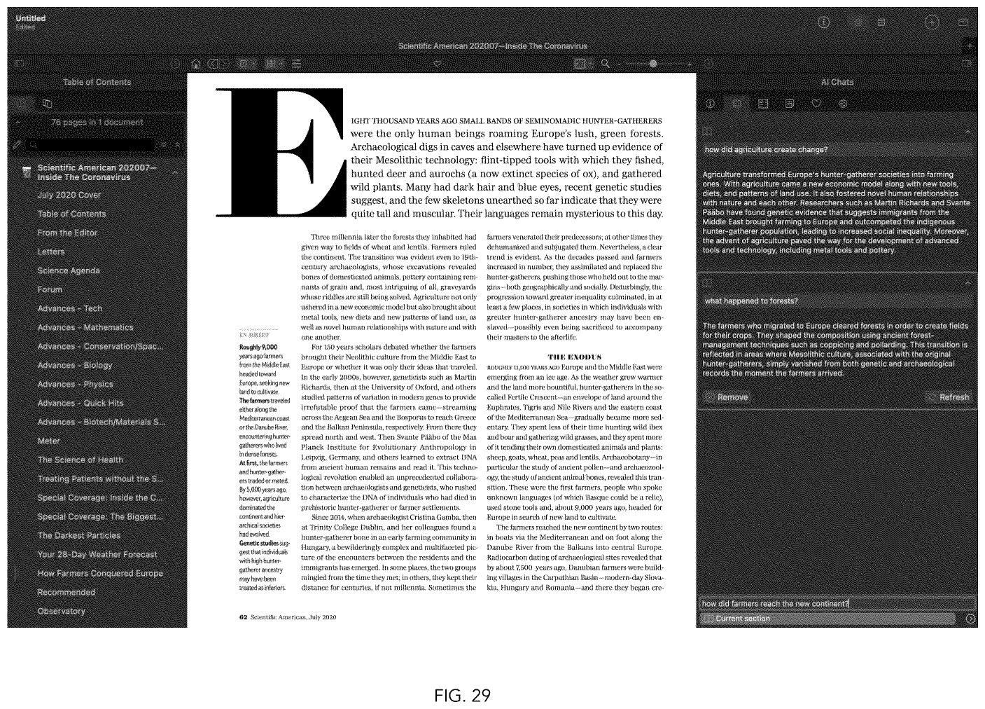

In FIG. 29, an AI chats tab is active. The user can enter any number of prompts to the chat and get a response for each from the AI engine. Each prompt-response pair is called a chat interaction and the chat is just a sequence of chat interactions. The scope of a prompt can be chosen using the dropdown menu below the prompt field. Available scopes include: the entire kBase, the selected documents, the current document, the current section, the current page, the current content selection, etc. The selected chat interaction can be refreshed or removed, while any other chat interaction must be selected first to make those operations available.

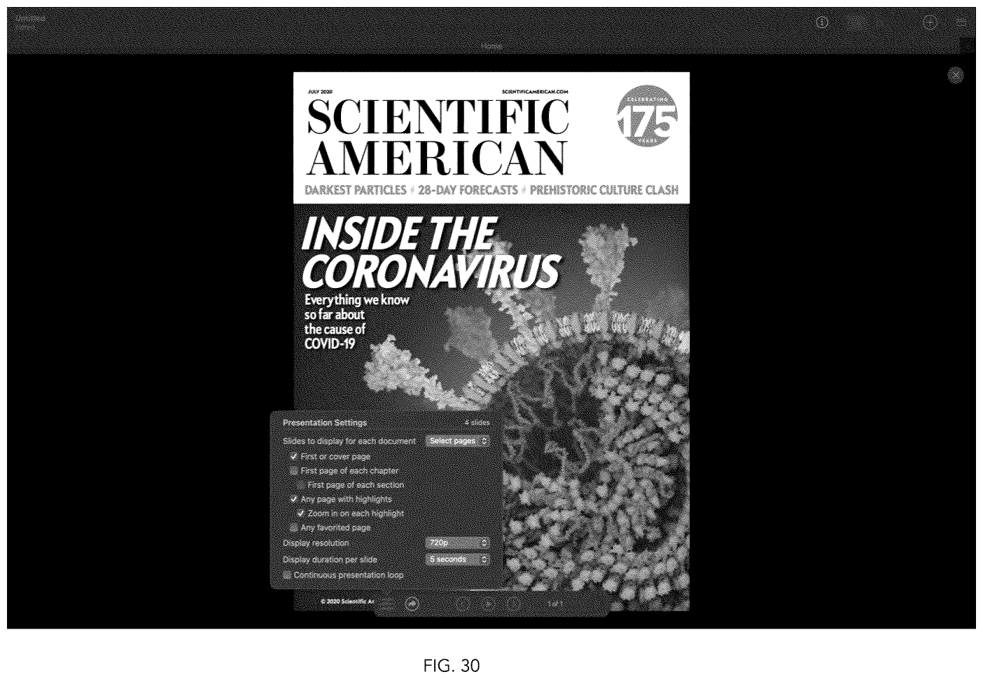

In FIG. 30, a playlist of documents was selected in the gallery, then the user entered presentation mode to display a sequence of slides. The presentation mode displays the current slide as well as a playback toolbar at the bottom, that disappears if the user stops moving the cursor for a short duration. There is also a button to exit presentation mode.

The user can show the presentation settings to configure the presentation by indicating which parts of the selected documents must be turned into slides, including cover pages, chapter pages, pages with highlights, and so forth.

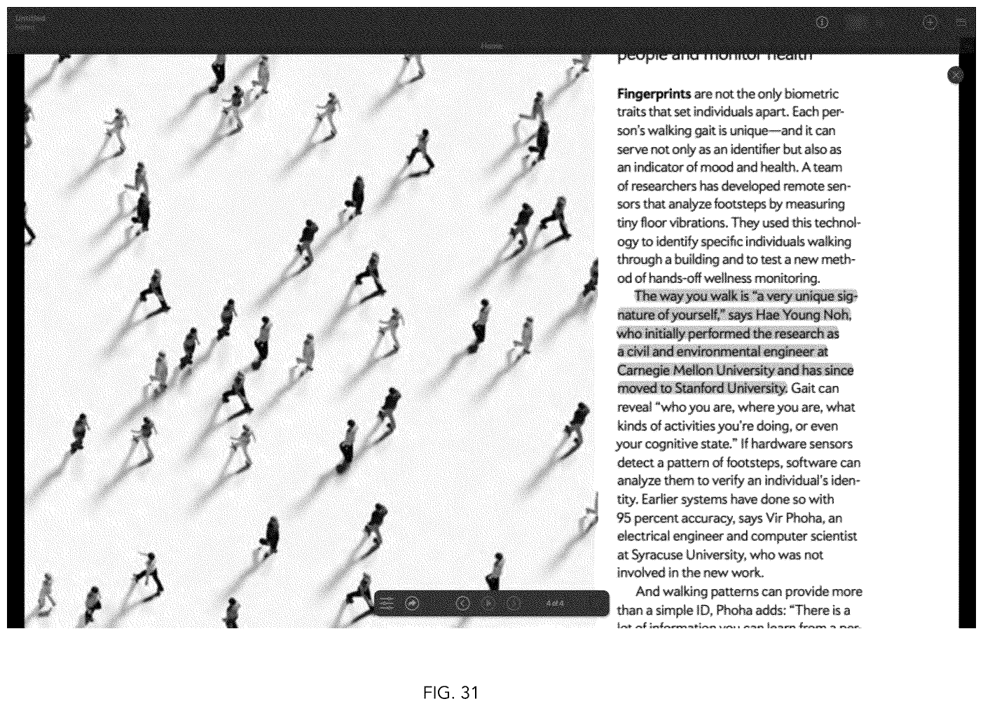

In FIG. 31, a presentation slide is displayed with a highlighted excerpt, in green. The comment attached to the corresponding note could be displayed if there was one. The user can move to the next slide or the previous slide, or play the entire presentation automatically.

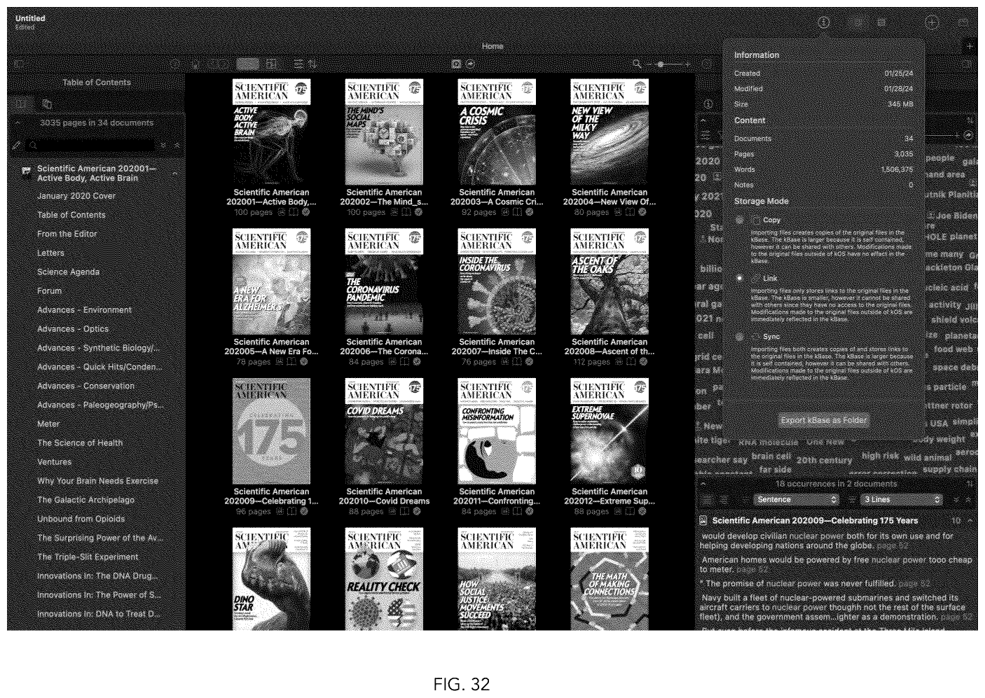

In FIG. 32, a kBase information bubble allows the information button in the main toolbar to be used to display information and statistics about the kBase. There is also a selector to switch the kBase's storage mode between copy, link, and sync (these modes are explained on the screenshot).

The granular aspects of the technology of the present invention allows objects and views to be used at and with any level of granularity: kBase, set, subset, document, chapter, page, excerpt, concept, etc. It should be noted, that the terms kBase, set, and element/document as used herein are equivalent to the terms space, subspace, and card. In addition, the term subset describes a subset of cards in a space or subspace.

Contexts provide the ability to see any space or subspace in any of the following contexts: gallery; table; timeline; calendar; map; board; virtual world (using virtual reality); or augmented world (using augmented reality).

The cards that make up a space or subspace are displayed in the chosen context based on their metadata. For example, documents may be shown on a map based on the locations that they reference or where they were last created, modified, or viewed; or in a timeline based on the periods that they reference or when they were last created, modified, or viewed.

It is further noted that the system has the ability to flatten any space or subspace to see it as a list instead of a tree of subspaces and cards; the ability to include presentation slides based on some query or configuration rather than manual editing; the ability to base presentation slides on notes with zoomed in excerpts and related comments; the ability to accurately identify the type of any PDF document (image only, image with hidden text, etc.); the ability to change the storage mode of any document (copy, link, or sync) to prioritize efficiency or portability; the ability to adjust the maximum affix (prefix or suffix) distance to the selected concept in the phrase builder; the ability to annotate any content or combination of content parts with highlight, tags, and comments (text, audio, or video); and the ability to explore the word cloud with pan and zoom, to decorate the concepts it displays (icons for entity types), etc.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A method of identifying associations and connections between one or more digital media, said method comprising:
providing a directory structure having a Space as a root directory;
assigning a function to the Space such that one or more digital media files stored there will be immediately processed in preparation for analysis according to the assigned function;
identifying a first digital media object and a second digital media from which information data can be extracted;
storing the first digital media and the second digital media in the Home Space;
creating a first Card that contains the data of the first digital media and a second Card that contains the data of the second digital media;
processing the first Card and the second Card by parsing text-based data to identify words, phrases and entities in each Card and storing them as an index in their respective first and second Cards;
selecting the first Card and the second Card;
performing a word cloud operation on the selected Cards to thereby identify associations between words, phrase or entities of the selected Cards;
and visually rendering the first Card and the second Card to thereby display the identified associations between the first Card and the second Card in terms of the words, phrases, and entities common to both of the Cards.

2. The method as defined in claim 1, wherein the method further comprises the step of creating one or more Sub-spaces that act as subfolders within the Space, wherein Sub-spaces may also be created within Sub-spaces, wherein a function may be assigned to the Sub-spaces, and wherein the function that is assigned to the Space and to each of the Sub-spaces may be a same or a different function.

3. The method as defined in claim 2, where in the method further comprises:
performing a search for at least one word or phrase in all of the Cards stored in the Space or in a selected Sub-space;
and generating a list of Cards that contain the at least one word or phrase.

4. The method as defined in claim 3, wherein the method further comprises generating a plurality of links to all locations in each of the Cards where the word or phrase appears.

5. The method as defined in claim 4, wherein the method further comprises generating a visual clue in the list of Cards that identifies all of the Cards where the word or phrase appears.

6. The method as defined in claim 2, wherein the method further comprises:
identifying a third digital media from which text-based data can be extracted;
storing the third digital media in the first Sub-Space;
creating a third Card that contains the data of the third digital media;
processing the third Card by parsing text-based data to identify words, phrases, or entities in the third Card and storing them as an index in the third Card;
and repeating the steps above each time that a new Card is stored in the Space or the selected Sub Space or when any of the existing Cards therein are modified.

7. The method as defined in claim 6, wherein the method further comprises:
selecting all of the Cards in the Space or the selected Sub-Space;
performing a word cloud operation on the selected Cards to thereby identify associations between the words, phrases, or entities of the selected Cards;
visually rendering all of the Cards to thereby display the identified associations between all of the Cards in terms of the words, phrases, or entities common to all of the Cards;
and repeating the steps above each time that a new Card is stored in the Space or the selected Sub Space or when any of the existing Cards therein are modified.

8. The method as defined in claim 2, wherein the method further comprises:
determining when a new media is stored in the Home Space or the selected Sub-Space;
identifying the new digital media as having text-based data, video data, audio data, image date, or a combination thereof.

9. The method as defined in claim 8, further comprising transcribing audio data from the digital media when it contains video data or audio data.

10. The method as defined in claim 1, wherein the at least one digital media comprises one or more of the group consisting of a kBase, a document, a chapter, a page, an exception, a concept, or a note.

11. The method as defined in claim 1, wherein the one or more digital media comprises one or more digital media object files.

12. The method as defined in claim 1, further comprising flattening any space or subspace to see it as a list instead of a tree of subspaces and cards.

13. The method as defined in claim 1, further comprising presentation slides based on a query or configuration.

14. The method as defined in claim 13, further comprising basing the presentation slides on notes with zoomed in excerpts and related comments.

15. The method as defined in claim 1, further comprising accurately identifying a type of any PDF document including text documents, images, images with hidden text or combinations thereof.

16. The method as defined in claim 1, further comprising changing a storage mode of any document between copy, link, or sync to prioritize efficiency or portability.

17. The method as defined in claim 1, further comprising adjusting a maximum affix, prefix or suffix distance to the selected concept in a phrase builder.

18. The method as defined in claim 1, further comprising annotating any content or combination of content parts with highlight, tags, and comments (text, audio, or video).

19. The method as defined in claim 1, further comprising exploring the word cloud with pan and zoom, to alter a display of visible concepts.

20. The method as defined in claim 19, wherein the visible concepts comprise icons for entity types.
